(19) United States
(12) Patent Application Publication
(10) Pub. No.: US 2012/0221485 A1
(43) Pub. Date: Aug. 30, 2012

(54) METHODS AND SYSTEMS FOR RISK MINING AND FOR GENERATING ENTITY RISK PROFILES

(76) Inventors: Jochen L. Leidner, Zug (CH); Frank Schilder, Saint Paul, MN (US)

(21) Appl. No.: 13/423,127

(22) Filed: Mar. 16, 2012

Related U.S. Application Data
(63) Continuation-in-part of application No. 12/628,426, filed on Dec. 1, 2009.

(51) Int. Cl. G06Q 40/06

(52) U.S. Cl. 705/36 R

(57) ABSTRACT

A computer implemented method for mining risks includes providing a set of risk-indicating patterns on a computing device; querying a corpus using the computing device to identify a set of potential risks by using a risk-identification-algorithm based, at least in part, on the set of risk-indicating patterns associated with the corpus; comparing the set of potential risks with the risk-indicating patterns to obtain a set of prerequisite risks; generating a signal representative of the set of prerequisite risks; storing the signal representative of the set of prerequisite risks in an electronic memory; and aggregating potential risks linked to an entity to an entity risk profile (ERP). A computing device or system for mining risks includes an electronic memory; and a risk-identification-algorithm based, at least in part, on the set of risk-indicating patterns associated with a corpus stored in the electronic memory.

### CROSS REFERENCE TO RELATED APPLICATION

The present application claims benefit of priority to and is a continuation-in-part of U.S. patent application Ser. No. 12/628,426, filed Dec. 1, 2009, and entitled METHOD AND APPARATUS FOR RISK MINING (Leidner et. al.), which is hereby incorporated by reference herein in its entirety.

### FIELD OF THE INVENTION

This invention generally relates to mining and intelligent processing of data collected from content sources, e.g., in areas of financial services and risk management. More specifically, this invention relates to providing data and analysis useful in recognizing investment related trends, threats and opportunities including risk identification using information mined from information sources.

### BACKGROUND OF THE INVENTION

Organizations operate in risky environments. Competitors may threaten their markets; regulations may threaten margins and business models; customer sentiment may shift and threaten demand; and suppliers may go out of business and threaten supply. Three main areas of risk are operational, change and strategic. World events such as terrorism, natural disasters and the global financial crisis have raised the profile of negative risk while events such as the advent and widespread use of the Internet represent positive risks. Now more than ever, organizations must plan, respond and recognize all forms of risks that they face. Risk management is a central part of operations and strategy for any prudent organization and requires as a core business asset the ability to identify, understand and deal with risks effectively to increase success and reduce the likelihood of failure. Early detection and response to risks is a key need for any business and other entity.

Currently, various risk alerts with respect to entities and activities are common. However, such risk alerts occur after the fact. While alerts as to the actual occurrence of an event which puts an entity or topic/concern at risk is important, the mining of potential risks is believed to be very useful in decision making with respect to such an entity or issue. In order to perform a meaningful risk assessment, it is often necessary to compile not only sufficient information, but information of the proper type in order to formulate a judgment as to whether the information constitutes a risk. Without the ability to access and assimilate a variety of different information sources, and particularly from a sufficient number and type of information sources, the identification, assessment and communication of potential risks is significantly hampered. Currently, gathering of risk-related information is performed manually and lacks defined criteria and processes for mining meaningful risks to provide a clear picture of the risk landscape.

With the advents of the printing press, typeset, typewriting machines, computer-implemented word processing and mass data storage, the amount of information generated by mankind has risen dramatically and with an ever quickening pace. As a result of the growing and divergent sources of information, manual processing of documents and the content therein is no longer possible or desirable. Accordingly, there exists a growing need to collect and store, identify, track, classify and catalogue, and process this growing sea of information/content and to deliver value added service to facilitate informed use of the data and predictive patterns derived from such information. Due to the development and widespread deployment of and accessibility to high speed networks, e.g., Internet, there exists a growing need to adequately and efficiently process the growing volume of content available on such networks to assist in decision making. In particular the need exists to quickly process information pertaining to corporate performance and events that may have an impact (positive or negative) on such performance so as to enable informed decision making in light of the effect of events and performance, including predicting the effect such events may have on the price of traded securities or other offerings.

In many areas and industries, including financial services sector, for example, there are content and enhanced experience providers, such as The Thomson Reuters Corporation, Wall Street Journal, Dow Jones News Service, Bloomberg, Financial News, Financial Times, News Corporation, Zawya, and New York Times. Such providers identify, collect, analyze and process key data for use in generating content, such as reports and articles, for consumption by professionals and others involved in the respective industries, e.g., financial consultants and investors. In one manner of content delivery, these financial news services provide financial news feeds, both in real-time and in archive, that include articles and other reports that address the occurrence of recent events that are of interest to investors. Many of these articles and reports, and of course the underlying events, may have a measureable impact on the trading stock price associated with publicly traded companies. Although often discussed herein in terms of publicly traded stocks (e.g., traded on markets such as the NMASDAQ and New York Stock Exchange), the invention is not limited to stocks and includes application to other forms of investment and instruments for investment and to all forms of entities, including persons, industry groups, etc. Professionals and providers in the various sectors and industries continue to look for ways to enhance content, data and services provided to subscribers, clients and other customers and for ways to distinguish over the competition. Such providers strive to create and provide enhance tools, including search and ranking tools, to enable clients to more efficiently and effectively process information and make informed decisions.

Advances in technology, including database mining and management, search engines, linguistic recognition and modeling, provide increasingly sophisticated approaches to searching and processing vast amounts of data and documents, e.g., database of news articles, financial reports, blogs, SEC and other required corporate disclosures, legal decisions, statutes, laws, and regulations, that may affect business performance and, therefore, prices related to the stock, security or fund comprised of such equities. Investment and other financial professionals and other users increasingly rely on mathematical models and algorithms in making professional and business determinations. Especially in the area of investing, systems that provide faster access to and processing of (accurate) news and other information related to corporate performance will be a highly valued tool of the professional and will lead to more informed, and more successful, decision making. Information technology and in particular information extraction (IE) are areas experiencing significant growth to assist interested parties to harness the vast amounts of information accessible through pay-for-services or freely available such as via the Internet.

More particularly, IE systems have been applied to the financial domain on Message Understanding Contest (MUC)-like tasks, ranging from named entity tagging to slot filling in templates. (Marco Costantino. 1992. Financial information extraction using pre-defined and user-definable templates in the LOLITA system. Proceedings of the Fifteenth International Conference on Computational Linguistics (COLING 1992), 4:241-255). Automatic Knowledge Acquisition is another area designed to extract knowledge from the growing sea of information available to users. Hearst (Marti Hearst. 1992. Automatic acquisition of hyponyms from large text corpora. In Proceedings of the Fourteenth International Conference on Computational Linguistics (COLING 1992)) pioneered the pattern-based extraction of hyponyms from corpora, which laid the groundwork for subsequent work, and which included extraction of knowledge from the World Wide Web (Web) (e.g., (Oren Etzioni, Michael J. Cafarella, Doug Downey, Stanley Kok, Ana-Maria Popescu, Tal Shaked, Stephen Soderland, Daniel S. Weld, and Alexander Yates. 2004. Web-scale information extraction in KnowItAll: preliminary results. In Stuart I. Feldman, Mike Uretsky, Marc Najork, and Craig E. Wills, editors, Proceedings of the 13th international conference on World Wide Web (WWW 2004), New York, N.Y., USA, May 17-20, 2004, pages 100-110. ACM)). To improve precision was the mission of (Zornitsa Kozareva, Ellen Riloff, and Eduard Hovy. 2008. Semantic class learning from the web with hyponym pattern linkage graphs. In Proceedings of ACL-HLT, pages 1048-1056, Columbus, Ohio, USA. Association for Computational Linguistics), which was designed to extract hyponymy, but they did so at the expense of recall, using longer dual anchored patterns and a pattern linkage graph. However, their method is by its very nature unable to deal with low-frequency items, and their system does not contain a chunker, so only single term items can be extracted. De Saeger et al. (Stijn De Saeger, Kentaro Torisawa, and Jun'ichi Kazama. 2008. Looking for trouble. In Proceedings of the 22^{nd} International Conference on Computational Linguistics (COLING 2008), pages 185-192, Morristown, N.J., USA. Association for Computational Linguistics.) describe an approach that extracts instances of the “trouble” or “obstacle” relations from the Web in the form of pairs of fillers for these binary relations. Their approach, which is described for the Japanese language, uses support vector machine learning and relies on a Japanese syntactic parser, which permits them to process negation.

Another area of development has been with regard to correlation of volatility and text. Kogan et al. (Shimon Kogan, Dimitry Levin, Bryan R. Routledge, Jacob S. Sagi, and Noah A. Smith. 2009. Predicting risk from financial reports with regression. In Proceedings of the Joint International Conference on Human Language Technology and the Annual Meeting of the North American Chapter of the Association for Computational Linguistics (HLT-NAACL)) studied the correlation between share price volatility, a proxy for risk, and a set of trigger words occurring in 60,000 SEC 10-K filings from 1995-2006. Because the disclosure of a company's risks is mandatory by law, SEC reports provide a rich source of content and information. Trigger words are selected a priori by humans. What is needed is a system that can perform risk mining to find risk-indicative words and phrases automatically and that can generate and maintain a risk-based profile.

Speculative Language & NLP. Light et al. (Marc Light, Xin Ying Qiu, and Padmini Srinivasan. 2004. The language of bioscience: Facts, speculations, and statements in between. In BioLINK 2004: Linking Biological Literature, Ontologies and Databases, pages 17-24. ACL) found that sub-string matching of 14 pre-defined string literals outperforms an SVM classifier using bag-of-words features in the task of speculative language detection in medical abstracts. Golberg et al. (Andrew B. Goldberg, Nathanael Fillmore, David Andrzejewski, Zhiting Xu, Bryan Gibson, and Xiaojin Zhu. 2009. May all your wishes come true: A study of wishes and how to recognize them. In Proceedings of Human Language Technologies: The 2009 Annual Conference of the North American Chapter of the Association for Computational Linguistics, pages 263-271, Boulder, Colo., June. Association for Computational Linguistics) were concerned with automatic recognition of human wishes, as expressed in human notes for Year's Eve. They use a bipartite graph-based approach, where one kind of node (content node) represents things people wish for (“world peace”) and the other kind of node (template nodes) represent templates that extract them (e.g., “I wish for ______”). Wishes can be seen as positive Q in the formalization of the present invention.

Many financial services providers use “news analysis” or “news analytics,” which refer to a broad field encompassing and related to information retrieval, machine learning, statistical learning theory, network theory, and collaborative filtering, to provide enhanced services to subscribers and customers. News analytics includes the set of techniques, formulas, and statistics and related tools and metrics used to digest, summarize, classify and otherwise analyze sources of information, often public “news” information. An exemplary use of news analytics is a system that digests, i.e., reads and classifies, financial information to determine market impact related to such information while normalizing the data for other effects. News analysis refers to measuring and analyzing various qualitative and quantitative attributes of textual news stories, such as that appear in formal text-based articles and in less formal delivery such as blogs and other online vehicles. More particularly, the present invention concerns analysis in the context of electronic content. Expressing, or representing, news stories as “numbers” or other data points enables systems to transform traditional information expressions into more readily analyzable mathematical and statistical expressions and further into useful data structures and other work product. News analysis techniques and metrics may be used in the context of finance and more particularly in the context of investment performance—past and predictive.

News analytics systems may be used to measure and predict: volatility of earnings, stock valuation, markets; reversals of news impact; the relation of news and message-board information; the relevance of risk-related words in annual reports for predicting negative or positive returns; and the impact of news stories on stock returns. News analytics often views information at three levels or layers: text, content, and context. Many efforts focus on the first layer—text, i.e., text-based engines/applications process the raw text components of news, i.e., words, phrases, document titles, etc. Text may be converted or leveraged into additional information and irrelevant text may be discarded, thereby condensing it into information with higher relevance/usefulness. The second layer, content, represents the enrichment of text with higher meaning and significance embossed with, e.g., quality and veracity characteristics capable of being further exploited by analytics. Text may be divided into “fact” or “opinion” expressions. The third layer of news analytics—context, refers to connectedness or relatedness between information items. Context may also refer to the network relationships of news.

Any number of events and potential events can have a significant effect on stock price behavior. A recent example of an event affecting valuation and behavior is the explosion, and resulting oil spill disaster, of an offshore drilling platform in the Gulf of Mexico off the Louisiana coast. This event greatly affected the financial performance of several entities, including publicly traded British Petroleum (“BP”). The news of the disaster had the immediate effect of causing BP common stock to decline sharply on the day of the disaster and days following but in addition there was a range of potential risks that could result following the accident. In addition to quantifiable financial losses associated with asset damage, oil clean-up costs, claims filed by those adversely affected by the spill, BP suffered from the resulting political and social fallout. The Exxon Valdez oil tanker grounding and spill is another example.

Presently, customers face a market of products that offer essentially the same human-driven research tool, albeit through different deployment methods and visualizations. Asset managers who serve risk-conscious retail and institutional investors need access to robust resources to consider entity-specific risks. The existing indicators of risk are single scalar values, if values at all, that are not capable of further analytics. Examples of such crude representations include: stock price (which arguably has a degree of inherent risk built into it); volatility (which merely reflects the current or actual volatility or stability of a stock price based on historical prices over a specified period with the last observation the most recent price, e.g., Alpha discussed below); implied volatility (a form of future volatility derived from the market price of a market traded derivative—in particular an option with the last date of the future period being the expiration date of the option); and value-at-risk (VaR) (a measure of the risk of loss on a specific portfolio of financial assets, a percentile of the predictive probability distribution for the size of a future financial loss). Volatility is limited in that it does not measure the direction of price changes, merely their dispersion.

In particular, a commonly used term and form of measurement related to risk of a company is “Alpha,” which represents a measure of performance on a risk-adjusted basis. For instance, Alpha considers the volatility (i.e., price risk) of an instrument, stock, bond, mutual fund, etc. and compares risk-adjusted performance to another performance measurement, e.g., a benchmark or other index. The return of the investment vehicle, e.g., mutual fund, as compared to the return of the benchmark, e.g., index, is the investment vehicle's Alpha. Alpha is one of five widely considered technical risk ratios. In addition to Alpha, other technical risk factor statistical measurements used in modern portfolio theory include: beta, standard deviation, R-squared, and the Sharpe ratio. These statistical risk indicators are used by investment firms to determine a risk-reward profile of a stock, bond or other instrument-based investment vehicle such as a mutual fund. In the case of a mutual fund, for example, a positive or negative Alpha of 1.0 means that the mutual fund has outperformed its benchmark index, respectively, by positive or negative 1%. Accordingly, if a capital asset pricing model analysis estimates that a portfolio should earn 10% based on the risk of the portfolio and the portfolio actually earns 15%, then the portfolio's alpha would be positive 5% and represents the excess return over what was predicted in the model analysis.

What is needed is a system capable of automatically processing or “reading” news stories, filings, and other content available to it and quickly interpreting the content to identify risks and to arrive at a higher understanding of assessing risks associated with an entity (company, person, industry, sector), beyond singular, scalar representations of risk. It is further needed to create and apply predictive models to anticipate behavior of stock price and other investment vehicles prior to the actual movement of such stocks and other investments based on an entity's risk assessment and profile and/or historical trending information and analytics. Presently, there exists a need to utilize and leverage media and other sources of entity information and a need for advanced analytics relevant to corporate performance, price behavior, investing, and reputational awareness to provide a risk-based solution. Given the vast amount of news, legal, regulatory and other entity-related information based on text, content and context, investors and those involved in financial services have a persistent need and desire for an understanding of how such vast amounts of information, even processed information, relates to the likely movement of a company's stock price.

### SUMMARY OF THE INVENTION

The present invention provides enhanced analytics that enable identifying and measuring and/or scoring risks associated with an entity, e.g., a publicly traded company, based at least in part on content obtained from news and other reliable sources and generating an entity-specific risk profile based on entity-specific risks. This first aspect of the invention allows investment managers, industry analysts and chief risk officers to work with a company-specific risk profile. In one manner of the invention the entity-specific risk profile is essentially a data structure based upon linguistic analysis wherein the data structure preferably comprises one or more or all of four parts. The four component risk parts that make up the data structure are: a set of general risks (a set of <risk type; risk exposure indicator> pairs for a set of risk types that are applicable to all companies); a set of idiosyncratic risks (a set of <risk type; risk exposure indicator> pairs for a set of risk types that characterize particularly the company under consideration); self trends (a set of historic signals and a forecasting trend that relates the company under consideration to its past overall risk exposure); and peer trends (a set of historic signals and a forecasting trend that relates the company under consideration to the past overall risk exposure of its industry peers). Known data structures have only a single risk component. The invention may take the form of a risk profile comprising two or more of one component part, e.g., general risks. Optionally, the invention may include one or more of idiosyncratic risks, self trends, and peer trends.

The invention further provides means for analyzing such risks, including trending (entity/self and peer) and historical comparison of data to generate predictive firm valuation behavior based on the entity-specific risk profile. After processing vast amount of news, legal, regulatory and other entity-related information based on text, content and context, the present invention provides investors and those involved in financial services with a risk profile and related analytics that impart meaning to such vast amounts of information and a useful tool to measure likely movement of a company's stock price based on a company's risk profile. The invention may be used to compare two or more companies to develop a risk-balanced portfolio of companies/securities comprising a fund or portfolio. In this manner, the invention assists fund and other managers in making decisions for the purposes of maintaining portfolios that are balanced or weighted with respect to risk.

Risk Mining has been described as the process of applying Web mining and information extraction to learning a taxonomy of risk types with little supervision. However, alerting humans to each and every individual occurrence of risk-indicative language is not feasible due to an abundance of strong and weak risk signals. The present invention provides a system that automatically aggregates entity risks and generates an entity-specific risk profile, for example, from a large corpus of electronic documents. The inventive entity risk profile (ERP) data structure represents a company's risk exposure as extracted and aggregated from unstructured textual data contained within documents from the corpus. The method may be performed by a system designed to receive a large corpus of news and other data and identify risks associated with a specific entity. This form of classifier may be evaluated in terms of P/R/F1 (Precision/Recall/F1 measure) scores as well as an extrinsic evaluation in terms of correlation with the VIX risk index (Chicago Board of Exchange CBOE Volatility Index—an option-based, weighted measure of the implied volatility).

In contrast to De Saeger et al., discussed above, and unlike their method, the present invention follows a more general, open-ended search process, which does not impose as much a priori knowledge. Also, De Saeger et al. created a set of pairs, whereas the approach of the present invention creates a taxonomy tree as output. Most importantly though, the present approach is not driven by frequency, and was instead designed to work especially with rare occurrences in mind to permit “black swan”-type risk discovery. As discussed above, Kogan et al. attempted to find a regression model uses very simple unigram features based on whole documents and that predicts volatility. In contrast, the present invention is directed to automatically extract patterns to be used as alerts.

In a first embodiment, the invention provides a computer implemented method comprising: automatically analyzing by a computer a set of linguistic characteristics of a set of information associated with an entity; based upon the step of automatically analyzing, automatically generating by the computer an entity-specific risk profile (“ERP”) associated with the entity, the entity-specific risk profile comprising a first risk component and a second risk component; and storing the entity-specific risk profile in a memory accessible by the computer. The first embodiment may be further characterized as follows: the first risk component and the second risk component are from a group comprising a financial risk component, a legal risk component, an operational risk component, and a markets risk component; the entity-specific risk profile further comprises a third risk component and a fourth risk component; the third risk component and the fourth risk component are from a group comprising a financial risk component, a legal risk component, an operational risk component, and a markets risk component; the set of information is derived from a corpus of electronic documents; the corpus is one or more of a group consisting of news, financial information, legal information, regulatory information, blogs, and event streams; automatically analyzing a set of linguistic characteristics comprises identifying a set of entity-specific risks based at least in part on a set of risk-indicating patterns associated with the corpus; automatically analyzing a set of linguistic characteristics comprises identifying a set of entity-specific risks by using a risk-identification-algorithm; the risk-identification-algorithm is based at least in part on one or more of a group consisting of a set of terms statistically associated with risk; a temporal factor; a set of customized criteria, including one or more of industry criterion, geographic criterion, monetary criterion, and political criterion; automatically transmitting an entity-specific alert upon detecting that the entity-specific risk profile meets or exceeds a predetermined risk value; automatically comparing a first entity-specific risk profile associated with a first entity with a second entity-specific risk profile associated with a second entity; using the results of comparing a first entity-specific risk profile associated with a first entity with a second entity-specific risk profile associated with a second entity to develop a risk-balanced portfolio of companies/securities comprising a fund or portfolio; providing an electronic link with the entity-specific risk profile to link a representation of the first risk component with the set of information from which the first risk component was derived; the entity is one of a group consisting of a company, a person, a politically exposed person (PEP), an industry, a sector, and a member of a corporate team; automatically analyzing by a computer a set of linguistic characteristics of a set of information associated with an entity includes applying a risk-based taxonomy; wherein the risk-based taxonomy is learned from the set of information; wherein the first risk component and the second risk component are from a group comprising: general risks; idiosyncratic risks, self trend; and peer trend; predicting a risk trend based on an historic time series; predicting a risk trend based on an historic time series further comprises applying a smoothing operation to mitigate outliers; generating a set of ERPs associated respectively with a set of entities.

In a second embodiment, the present invention provides a computer-based system comprising: a processor adapted to execute code; a memory for storing executable code; an input adapted to receive a set of information derived from a set of media information sources; a first set of code when executed by the processor being adapted to automatically analyze a set of linguistic characteristics of the set of information, and to identify risks associated with an entity; a second set of code when executed by the processor being adapted to automatically generate an entity-specific risk profile (“ERP”) associated with the entity based on the identified risks and to store the ERP in the memory, the entity-specific risk profile comprising a first risk component and a second risk component; and an output adapted to transmit a signal associated with the generated ERP.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a depiction of a prerequisite of an event forming a risk according to the present invention;

FIG. 2 is a schematic of a device for mining risks according to the invention;

FIG. 3 is a schematic of the operation for mining risks according to the invention;

FIG. 4 depicts an embodiment of risk clustering according to the invention;

FIG. 5 depicts another embodiment of risk clustering according to the invention;

FIGS. 6-13 are risk mining examples according to the invention;

FIG. 14 represents a computer-based implementation of the invention;

FIGS. 15-16 are examples of ERP generation systems that employ risk mining techniques for use in implementing the present invention;

FIG. 17A is a flow diagram illustrating a first embodiment of the ERP generation method of the present invention;

FIG. 17B is a flow diagram illustrating a first embodiment of the method using ERPs to predict stock movement of the present invention;

FIG. 18 is an exemplary screen shot showing a user interface related to the ERP generation system of the present invention;

FIG. 19 is a graphical representation of the General risk type resulting from use of the ERP system of the present invention and showing components of that type;

FIG. 20 is a graphical representation of the Idiosyncratic risk type resulting from use of the ERP system of the present invention and showing components of that type;

FIG. 21 is a graphical representation of the Self Trend risk type resulting from use of the ERP system of the present invention and showing components of that type;

FIG. 22 is a graphical representation of the Peer Trend risk type resulting from use of the ERP system of the present invention and showing components of that type;

FIGS. 23-26 are exemplary graphical representations of expressions of risk and of comparisons of risk related to use of the present invention.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

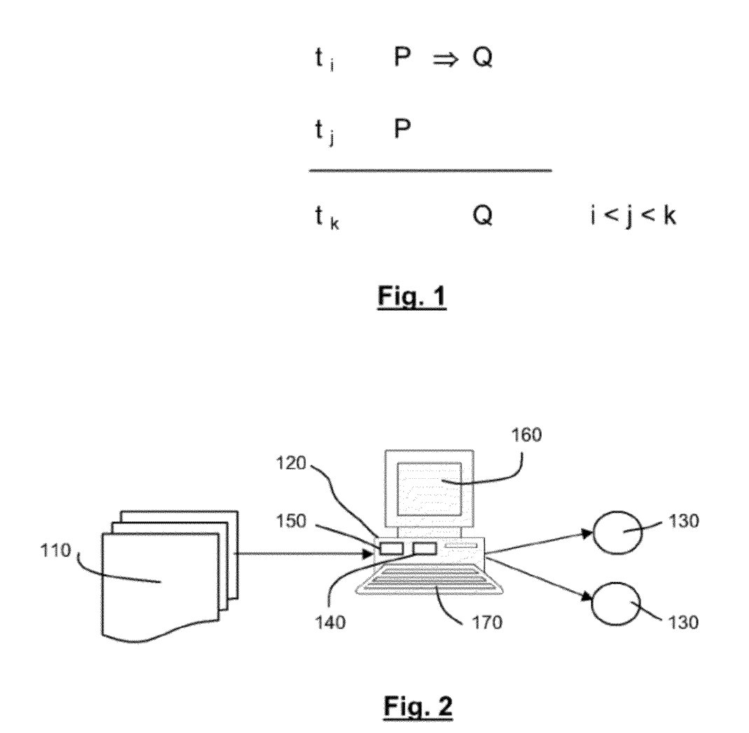

FIG. 1 illustrates how a risk materializes over time. Initially, a Risk, P=>Q, is extracted from a large textual database at time where Q stands for a high-impact event and P stands for a prerequisite of Q which is causally or statistically connected to Q and precedes Q in time. Unless otherwise stated or indicated herein, the implication symbol “=>” captures the causality and/or enablement relation holding between P and Q (e.g., P causes Q, or P is likely to enable Q). The implication symbol “=>” is not meant to be a material implication. Later at time, tⱼ, P might happen, which in turn may lead to Q occurring at time tₖ. The present invention solves the problem of obtaining risks P=>Q automatically from text and describes how a risk P=>Q and a prerequisite P may be used to alert a user that event Q may be imminent. As used herein, the term risk, which may be positive or negative, refers to an event involving uncertainty unless the event has occurred, which may result from a factor, thing, element, or course. In particular, as used herein, the term risk, which may be positive or negative, refers to a prerequisite for an event where the prerequisite is causally or statistically connected to the event and precedes the event in time. As used herein, the term prerequisite refers to a statement or an indication relating to a particular subject. In particular, the term prerequisite refers to a statement or an indication relating to a particular event, either directly or through the mining techniques of the present invention.

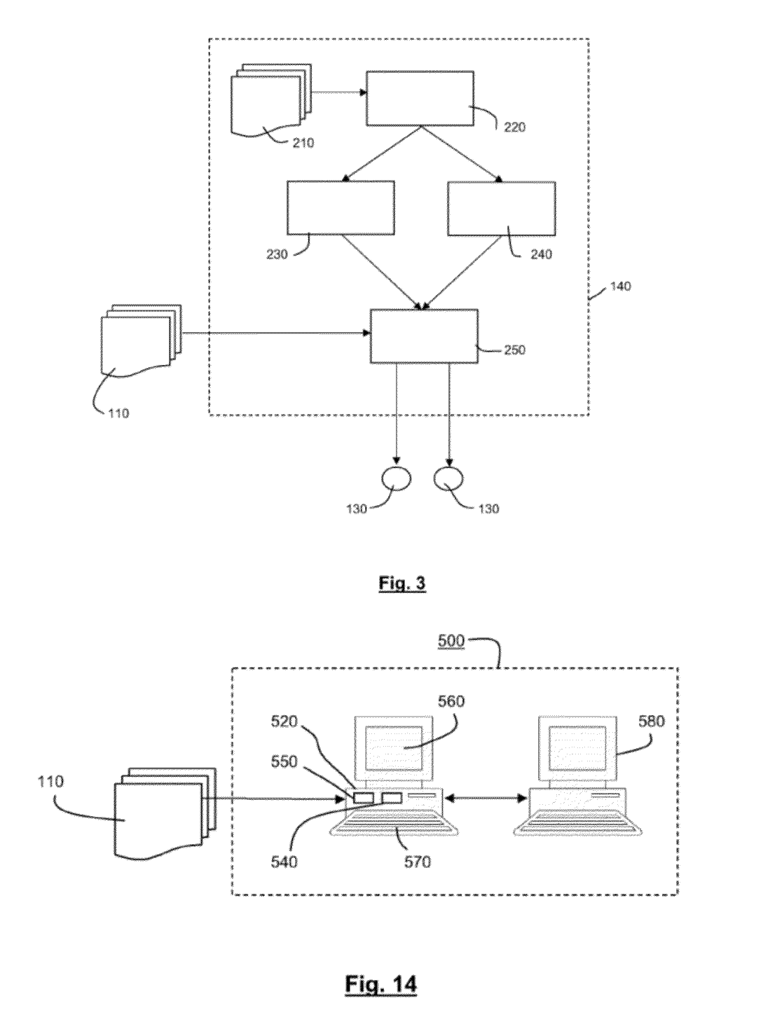

FIGS. 2 and 3 illustrate the overall process of the present invention. As depicted in FIG. 2, a corpus 110, for example a set(s) of textual feed(s), is mined for risk through use of a computing device 120. Computing device 120 may be, for example, a personal computing device (or alternatively a distributed form of processing and storage) that includes one or more processors and memory and electronic storage, i.e., computer readable medium for receiving and storing non-transitory data and executable code or machine instructions. As used herein, the term corpus and its variants refer to a set or sets of data, in particular digital data including textual data. The corpus 110 may include, but is not limited to, news; financial information, including but not limited to stock price data and its standard derivation (volatility); governmental and regulatory reports, including but not limited, to government agency reports, regulatory filings such as tax filings, medical filings, legal filings, Food and Drug Administration (FDA) filings, Security and Exchange Commission (SEC) filings; private entity publications, including but not limited to, annual reports, newsletters, advertising and press releases; blogs; web pages; event streams; protocol files; status updates on social network services; emails; Short Message Services (SMS); instant chat messages; Twitter tweets; and/or combinations thereof. The computing device 120 surveys corpus 110 to extract risk-indicating patterns and to seed the risk-identification-algorithm 140 with risk-indicative seed patterns for subsequent risk mining by an analyst or user. The computing device 120 contains or includes the risk-identification-algorithm 140 and may further include an interface 170 for querying the computing device 120, such as a keyboard, and a display device 160 for displaying results from the computing device 120.

The computing device 120 may also be used to alert users 130 through a computer interface (not shown) of risks, including but not limited to imminent risks, i.e., risks that are likely to occur including, but not limited to, likely to occur in the near future or a defined time period. Typically, the users 130 are alerted via a computing device (not shown). The present invention, however, is not so limited, and any device having a visual display or even a voice communication may suitably be used. As used herein, the term “computing device” refers to a device that computes, especially a programmable electronic machine that performs high-speed mathematical or logical operations or that assembles, stores, correlates, or otherwise processes information. Examples include, without limitation, mainframe computers, personal computers and handheld devices. Before mining the corpus 110 for risk, the present invention utilizes the computing device 120 to extract risk-indicating patterns from corpus or corpora of textual data. As used herein, risk-indicating patterns are patterns developed through the techniques of the present invention which relate possible prerequisites to possible events.

As depicted in FIG. 3, operation of the risk-identification-algorithm 140 involves execution of various code segments or modules by the computing device 120. The operation is performed on a corpus 210 and risk-identification-algorithm 140 includes the following executable code sets or modules: a risk miner 220, a risk type classifier 230, a risk clusterer 240 and a risk alerter 250, as described herein below. The risk miner 220 searches the corpus 210 of textual data for instances of a set of risk-indicative seed patterns to create a risk database. The corpus 210 may include, but is not limited to, news; financial information, including but not limited to stock price data and its standard derivation (volatility); governmental and regulatory reports, including but not limited, to government agency reports, regulatory filings such as tax filings, medical filings, legal filings, Food and Drug Administration (FDA) filings, Security and Exchange Commission (SEC) filings; private entity publications, including but not limited to, annual reports, newsletters, advertising and press releases; blogs; web pages; event streams; protocol files; status updates on social network services; emails; Short Message Services (SMS); instant chat messages; Twitter tweets; and/or combinations thereof. The corpus 210 may be the same as corpus 110 or may be different.

In one embodiment of the invention, trigger keywords are used (e.g. “risk”, “threat”) to generate the risk database. In another embodiment, regular expressions are used (e.g. “(“may”)? pose(s)? (a)? threat(s)? to”) to generate the risk database. Candidate risk sentences or sentence sequences are created, and new patterns are generalized by running a named entity tagger or Part of Speech (POS) tagger, and chunker (entities can be described by proper nouns or NNPs, and not just given by named entities) over it, and by substituting entities by per-class placeholder (e.g. “J.P. Morgan”=>“<COMPANY>”). These generated patterns can be used for re-processing the corpus, in one embodiment of the present invention after some human review, or automatically in another embodiment. The extracted sentences or sentence sequences are then both validated (whether or not they are really risk-indicating sentences) and parsed into risks of the form P=>Q (i.e. finding out which text spans correspond to the precondition “P”, which parts express the implication “=>”, and which parts express the high-impact event “Q”), using, but not limited to, the following non-limiting features: a set of terms with significant statistical association with the term “risk” (in one embodiment of this invention, statistical programs, such as Pointwise Mutual Information (PMI) and Log Likelihood, or rules, including but not limited to rules obtained by Hearst pattern induction, may be used to determine the set of terms); a set of binary gazetteer features, where the feature fires if a gazetteer a set of risk-indicative terms (“threat”, “bankruptcy”, “risk”, . . . ) compiled by human experts or extracted from hand-labeled training data; a set of indicators of speculative language; instances of future time reference; occurrences of conditionals; and/or occurrences of causality markers.

In one embodiment of the present invention, a variant of surrogate machine-learning (i.e., technology for machine learning tasks by examples) may be used to create training data for a machine-learning based classifier that extracts risk-indicative sentences. One useful technique is described by Sriharsha Veeramachaneni and Ravi Kumar Kondadadi in “Surrogate Learning—From Feature Independence to Semi-Supervised Classification”, Proceedings of the NAACL HLT Workshop on Semi-supervised Learning for Natural Language Processing, pages 10-18, Boulder, Colo., June 2009, Association for Computational Linguistics (ACL), the contents of which is incorporated herein by reference.

A risk type classifier 230 classifies each risk pattern by risk type (“RT”), according to a pre-defined taxonomy of risk types. In one embodiment of the present invention, this taxonomy may use, but not limited to, the following non-limiting classes: Political: Government policy, public opinion, change in ideology, dogma, legislation, disorder (war, terrorism, riots); Environmental: Contaminated land or pollution liability, nuisance (e.g., noise), permissions, public opinion, internal/corporate policy, environmental law or regulations or practice or ‘impact’ requirements; Planning: Permission requirements, policy and practice, land use, socio-economic impact, public opinion; Market: Demand (forecasts), competition, obsolescence, customer satisfaction, fashion; Economic: Treasury policy, taxation, cost inflation, interest rates, exchange rates; Financial: Bankruptcy, margins, insurance, risk share; Natural: Unforeseen ground conditions, weather, earthquake, fire, explosion, archaeological discovery; Project: Definition, procurement strategy, performance requirements, standards, leadership, organization (maturity, commitment, competence and experience), planning and quality control, program, labor and resources, communications and culture; Technical: Design adequacy, operational efficiency, reliability; Regulatory: Changes by regulator; Human: Error, incompetence, ignorance, tiredness, communication ability, culture, work in the dark or at night; Criminal: Lack of security, vandalism, theft, fraud, corruption; Safety: Regulations, hazardous substances, collisions, collapse, flooding, fire, explosion; and/or Legal: Changes in legislation, treaties.

A risk clusterer 240 groups all risks in the risk database by similarity, but without imposing a pre-defined taxonomy (data driven). In one embodiment Hearst pattern induction may be used. Hearst pattern induction was first mentioned in Hearst, Marti, “WordNet: An Electronic Lexical Database and Some of its Applications”, (Christiane Fellbaum (Ed.)), MIT Press 1998, the contents of which is incorporated herein by reference. In another embodiment of the present invention a number k is chosen by the system developer, and the kNN-means clustering method may be used. Further details of kNN clustering is described by Hastie, Trevor, Robert Tibshirani and Jerome Friedman, “The Elements of Statistical Learning: Data Mining, Inference, and Prediction”, Second Edition Springer (2009), the content of which is incorporated herein by reference. In such a case, the risks are grouped into a number, i.e. k, of categories and then classified by choosing the cluster with the highest similarity to a cluster of interest. In another embodiment of the present invention, hierarchical clustering is used. Alternatively or in addition to, both k-means clustering and hierarchical clustering may be used.

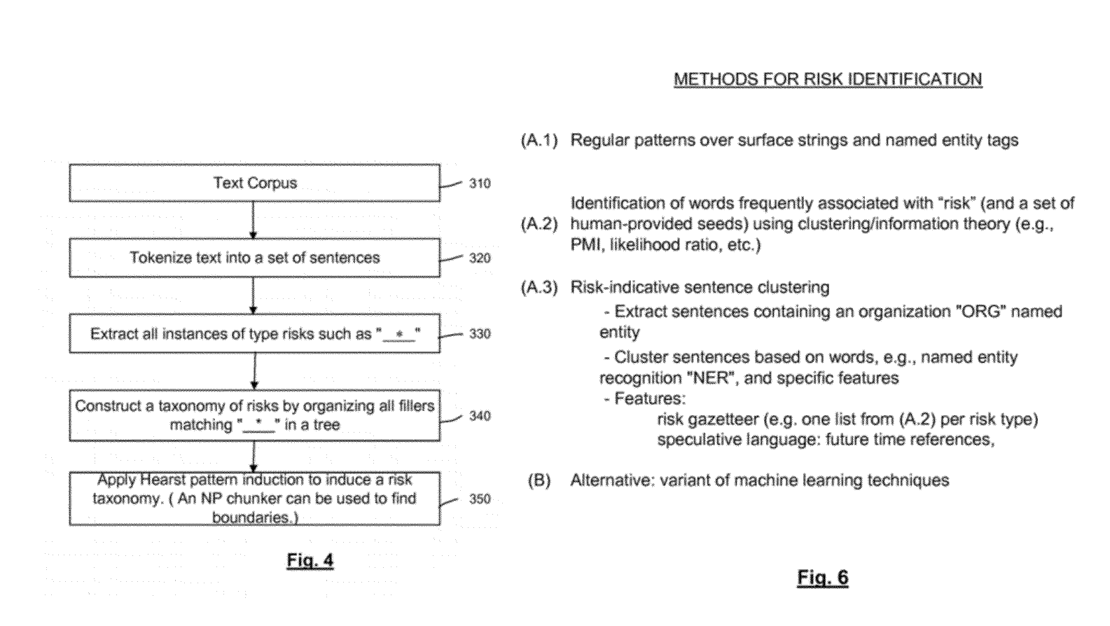

FIG. 4 depicts one embodiment of the risk clusterer 240 according to the present invention. At step 310, a text corpus is provided. At step 320, the text corpus is tokenized into a set of sentences. At step 330, all instances of a risk, which is indicated by “*”, is extracted from the tokenized text. At step 340, a taxonomy of risks is constructed into a tree by organizing all fillers matching the risk, i.e.“*”. At step, 350, Hearst pattern induction may be used to induce the risk taxonomy. Further, an NP chunker may be used to find the boundaries of interest.

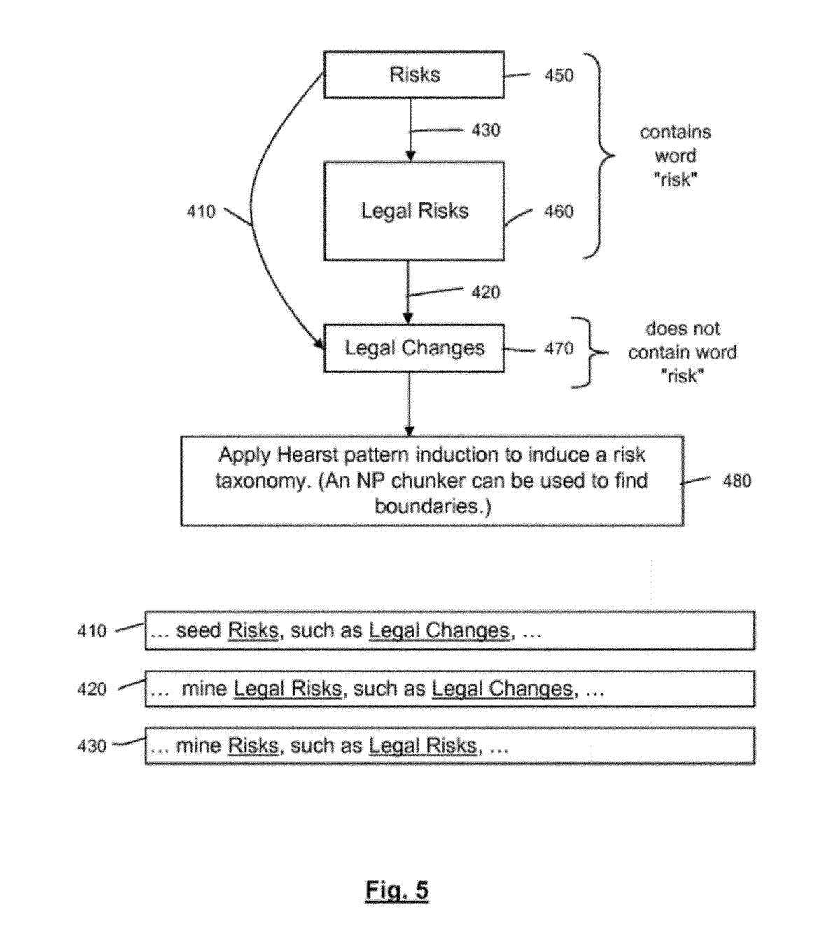

FIG. 5 depicts another embodiment of the risk clusterer 240 according to the present invention. In this embodiment, a risk taxonomy is created from, for example risks 450, legal risks 460 and legal changes 470. Risks 450, such as those that may be associated with legal changes 470, are seeded, as indicated by 410. Legal risks 460, such as legal changes 470, are mined by the computing device 120, as indicated by 420. Risks 450 are also mined for legal risks 470, as indicated by 430. In such a manner there is feedback for the legal risks 460 based on the risks 450 and the legal changes 460. The mining of the risks 450 and the legal risks 460 may include mining with the word or character string “risk” or an equivalent thereto. The mining of the legal changes 470 does not necessarily include the word risk. Advantageously, the taxonomy resulting from this process contains risk-indicative phrases that do not necessarily contain the word “risk” itself. Such taxonomy may be used in the risk-mining patterns in addition to their use for risk-type classification.

A risk alerter 250, as illustrated in FIG. 2, performs a similarity matching operation between the risks in the database and likely instances of P or Q in a textual feed 110. If evidence for P is found, the risk P=>Q is “imminent”. If evidence for Q is found, the risk P=>Q has materialized. In one embodiment of the present invention, the risk alerter 250 passes warning notifications to a user 130 directly.

As a result, when inspecting the risk database the user 130 (e.g. a risk analyst) can take immediate action before the risk materializes and increase the priority of the management of imminent risks (“P!, . . . , P!, P!, P!, . . . P! . . . ”) in the textual feed and materialized risks (“Q!”) as events unfold, without having to even read the textual feeds.

In one embodiment of the present invention, the output of the risk alerter 250 is connected to the input of a risk routing unit (not shown in FIGS. 2-3), which notifies an analyst whose profile matches the risk type RT. For example, an analyst may want to know about environmental risks. The risk alerter 250 would alert the analyst about an environmental risk when a prerequisite of a possible environmental event is mined. For example, the analyst may be alerted to an environmental risk of global warming when industrial activity increases in a particular country or region.

In one embodiment of the present invention, a set of risk descriptions as extracted from the corpus defined as the set of all past Security Exchange Commission (“SEC”) filings is matched to the risks extracted from the textual feed. The method proposes one risk description or a ranked list of alternative risk descriptions for inclusion in draft SEC filings for the company operating the system, in order to ensure compliance with SEC business risk disclosure duties.

The present invention may use a variety of methods for risk identification. For example, as depicted in FIG. 6, risk mining may include baseline monitoring of regular patterns over surface strings and named entity tags; identification of words frequently associated with risk using clustering information theory; and/or risk-indicative sentence clustering. Alternatively or in addition to, technology for machine learning of tasks by example may be used. The risk identification includes the querying of a corpus or corpora for risk indicating patterns. The query result may match all, substantially all or some of the risk indicating patterns. The number of occurrences or particular risk indicating patterns may also be used in the risk mining techniques of the present invention.

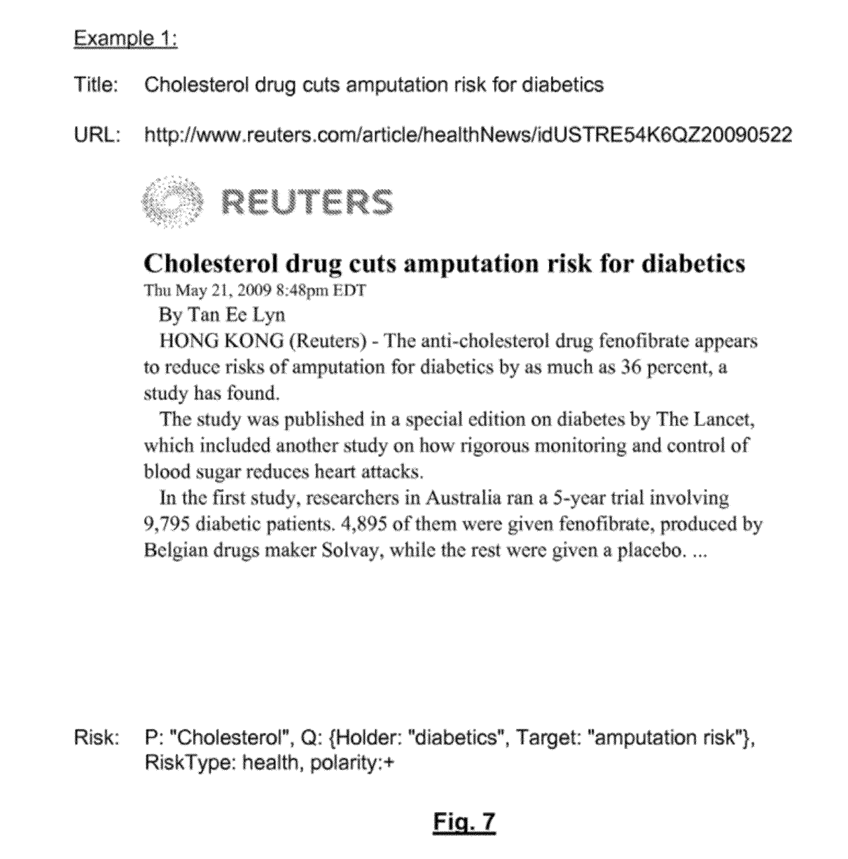

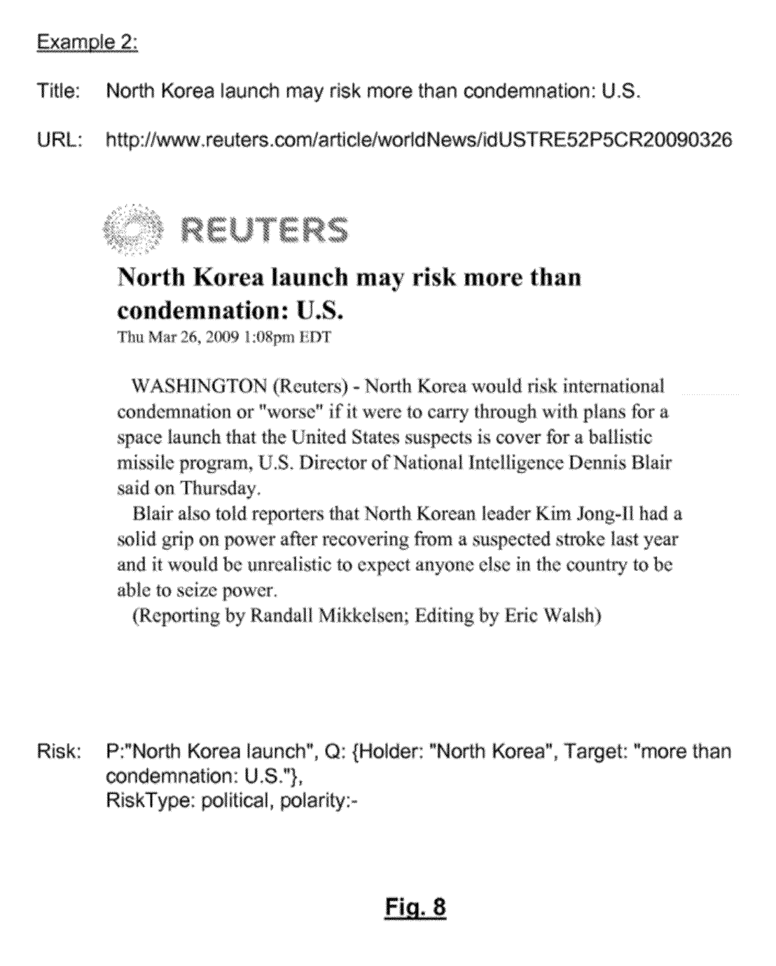

FIGS. 7 and 8 illustrate examples of risk mining according to the present invention. In Example 1 of FIG. 7, the corpus, including the listed news article, is mined for the term “cholesterol” as P or a prerequisite of Q or an event. The event Q is further classified by a holder “diabetics” and a target “amputation risk”. The Risk Type RT is health and has a positive polarity as being beneficial to health. For purposes of the present invention, the term risk not only refers to negative or harmful events, but also may refer to positive or beneficial results. In other words, a risk may have a positive impact and/or a negative impact. In Example 2 of FIG. 8, the corpus, including the listed news article, is mined for the phrase “North Korea launch” as P or a prerequisite of Q or an event. The event Q is further classified by a holder “North Korea” and a target “more than condemnation: U.S.”. The Risk Type RT is political and has a negative polarity as being harmful to world politics. Moreover, such negative and/or positive polarities may also be weighted for degree of the risk. In such a case it may be beneficial to alert the user 130 to a very harmful or very beneficial risk to a greater degree than for a less consequential risk.

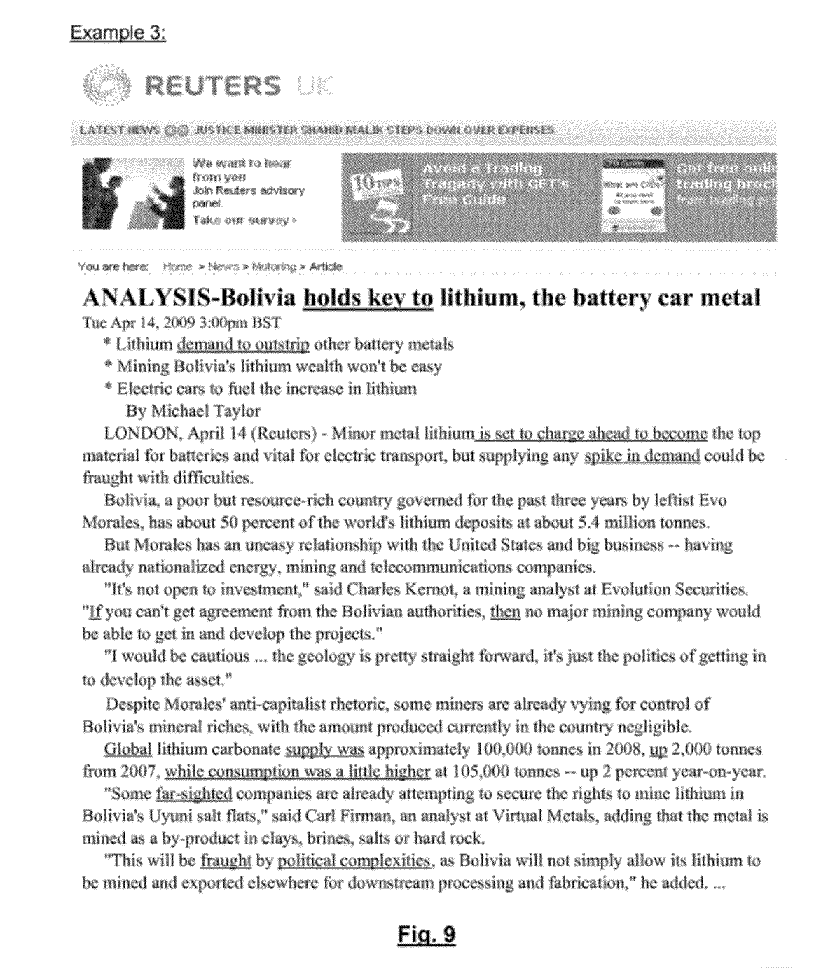

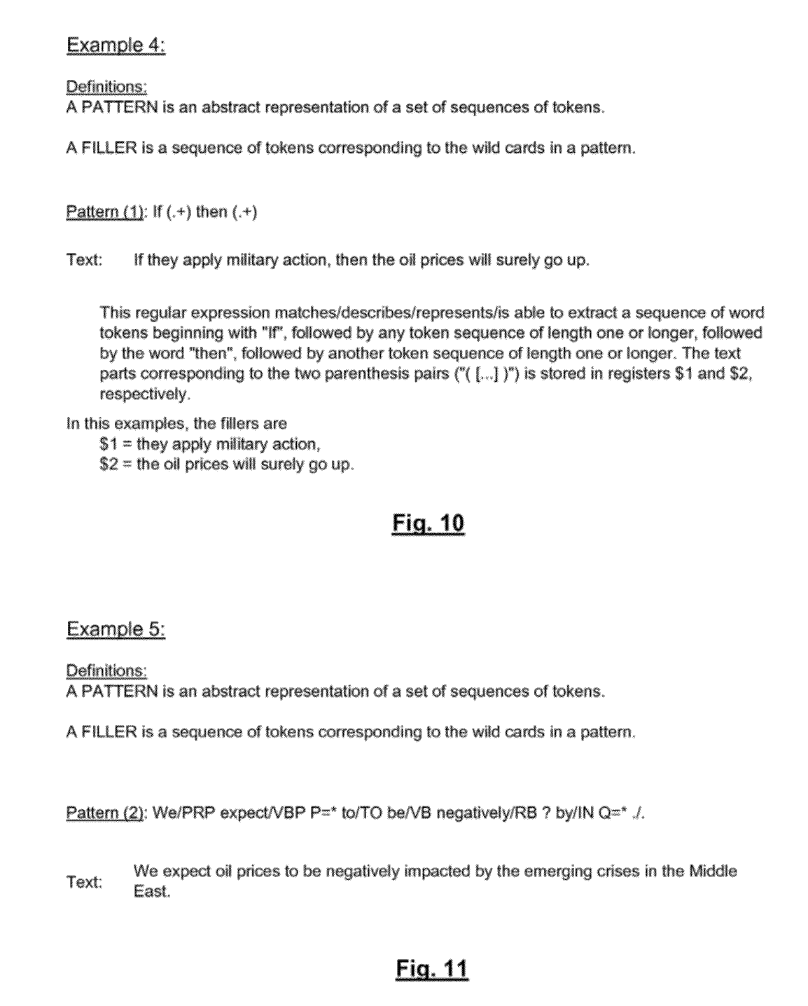

FIG. 9 illustrates another example of risk mining according to the present invention. In Example 3, the news article is mined. As background, demand for the metal lithium is increasing with limited supplies being available. Much of the metal is obtained from Bolivia, which at the time of this article has a government which may be viewed by some not to be friendly to capitalistic governments or businesses. The article is mined for a variety of potential words, sequences of words, and/or partial phrases to query the article for prerequisite P of events Q which may lead to risk, as indicated by the underlined words and/or sequences. The risk types present in the article include supply-demand risk and political risk.

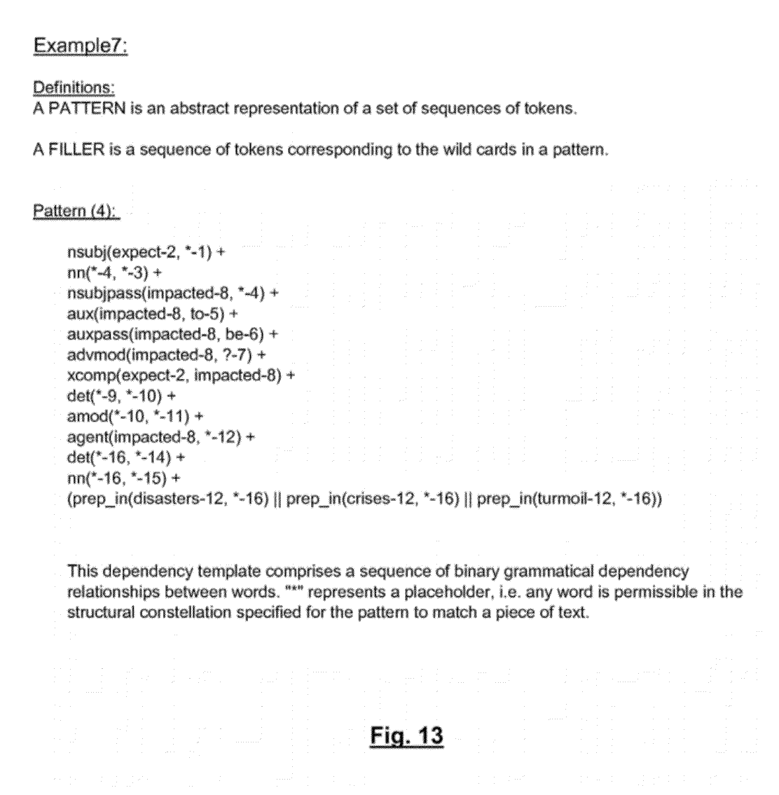

FIG. 10 illustrates another example of risk mining according to the present invention. In Example 4a, a corpus is mined for a pattern having specific tokens, i.e., “if” and “then.” The mining extracts sequences beginning with or having these tokens. The length of the sequence is not limited to any particular length or number of words, but is determined by tokens. The sequences are stored in registers, for example in the computing device 120. The use of patterns, however, such as, but not limited to those shown in FIG. 13, may be more precise than using a keyword-based ranked retrieval.

FIG. 11 illustrates another example of risk mining according to the present invention. In Example 5a, a corpus is mined according to syntax or grammatical structure of sentences or phrases. In this example normal PENN Treebank classes or tags or slightly modified PENN tags are used. Further details of Penn Treebank may be found at http://www.cis.upenn.edu/.about.treebank/ (PENN Treebank homepage), the contents of which is incorporated herein by reference, or by contacting Linguistic Data Consortium, University of Pennsylvania, 3600 Market Street, Suite 810, Philadelphia, Pa. 18104. For languages other than English, corresponding tag sets have been established and are known to one of ordinary skill in the art. In this example the tag “PRP” refers to a personal pronoun, i.e., “we” in the example sentence. The tag “VBP” refers a non-third person singular present tense verb, i.e. “expect” in the example sentence. The tag “TO” simply refers to the word “to” in the example sentence. The “VB” tag refers to a base form verb, i.e. “be” in the example sentence. The “RB” tag refers to an adverb, i.e., “negatively” in the example sentence. The “IN” tag refers to a preposition or subordinating conjunction, i.e. “by” in the example sentence. Some of the common PENN Treebank word P.O.S. tags include, but are not limited to, CC—Coordinating conjunction; CD—Cardinal number; DT—Determiner; EX—Existential there; FW—Foreign word; IN—Preposition or subordinating conjunction; JJ—Adjective; JJR—Adjective, comparative; JJS—Adjective, superlative; LS—List item marker; MD—Modal; NN—Noun, singular or mass; NNS—Noun, plural; NNP—Proper noun, singular; NNPS—Proper noun, plural; PDT—Predeterminer; POS—Possessive ending; PRP—Personal pronoun; PRP$—Possessive pronoun (prolog version PRP-S); RB—Adverb; RBR—Adverb, comparative; RBS—Adverb, superlative; RP—Particle; SYM—Symbol; TO—to; UH—Interjection; VB—Verb, base form; VBD—Verb, past tense; VBG—Verb, gerund or present participle; VBN—Verb, past participle; VBP—Verb, non-3rd person singular present; VBZ—Verb, 3rd person singular present; WDT—Wh-determiner; WP—Wh-pronoun; WP$—Possessive wh-pronoun (prolog version WP-S); and WRB—Wh-adverb.

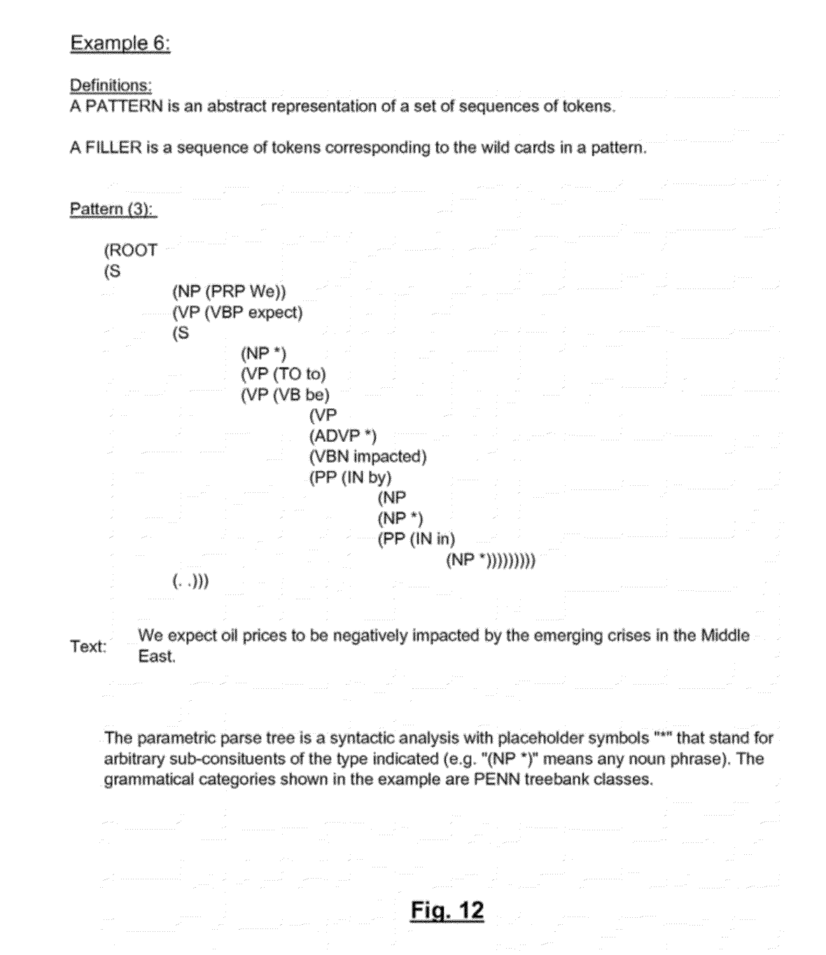

In FIG. 12, Example 6 illustrates another mining sequence or algorithm based on PENN treebank tags. Thus, as shown in FIGS. 11 and 12, the mining techniques of the present invention may analyze the same sentence under different criteria to obtain risks or prerequisites for risks.

In FIG. 13, risk mining according to the present invention is accomplished by a sequence of binary grammatical dependency relationships between words, including placeholders.

The above-described examples and techniques for mining risks may be used individually or in any combination. The present invention, however, is not limited to these specific examples and other patterns or techniques may be used with the present invention. The mined patterns from these examples and/or from the techniques of the present invention may be ranked according to ranking algorithms, such as, but not limited to, statistical language models (LMs), graph-based algorithms (such as PageRank or HITS), ranking SVMs, or other suitable methods.

In one aspect of the present invention a computer implemented method for mining risks is provided. The method includes providing a set of risk-indicating patterns on a computing device 120; querying a corpus 110 using the computing device 120 to identify a set of potential risks by using a risk-identification-algorithm 140 based, at least in part, on the set of risk-indicating patterns associated with the corpus 110; comparing the set of potential risks with the risk-indicating patterns to obtain a set of prerequisite risks; generating a signal representative of the set of prerequisite risks; and storing the signal representative of the set of prerequisite risks in an electronic memory 150. The method may further include determining an imminent risk from the prerequisite risks, the imminent risk being determined using the risk-identification-algorithm 140, the imminent risk being associated with at least one risk from the set of prerequisite risks; generating a signal representative of the imminent risk; and storing the signal representative of the imminent risk in the electronic memory 150. Still further, the method may further include, after storing the signal representative of the set of prerequisite risks, determining a materialized risk, the materialized risk being determined using the risk-identification-algorithm 140, the materialized risk being associated with the set of risks; generating a signal representative of the materialized risk; and storing the signal representative of the materialized risk in the electronic memory 150. Moreover, the method may still further include, after storing the signal representative of the imminent risk, determining a materialized risk, the materialized risk being determined using the risk-identification-algorithm 140, the materialized risk being associated with the imminent risk; generating a signal representative of the materialized risk; and storing the signal representative of the materialized risk in the electronic memory 150.

Desirably, the corpus 110 is digital. The corpus 110 may include, but is not limited to, news; financial information, including but not limited to stock price data and its standard derivation (volatility); governmental and regulatory reports, including but not limited, to government agency reports, regulatory filings such as tax filings, medical filings, legal filings, Food and Drug Administration (FDA) filings, Security and Exchange Commission (SEC) filings; private entity publications, including but not limited to, annual reports, newsletters, advertising and press releases; blogs; web pages; event streams; protocol files; status updates on social network services; emails; Short Message Services (SMS); instant chat messages; Twitter tweets; and/or combinations thereof.

The risk-identification-algorithm 140 may be based upon various factors and/or criteria. For example, the risk-identification-algorithm 140 may be based upon, but not limited to, a set of terms statistically associated with risk; upon a temporal factor; upon a set of customized criteria, etc. and combinations thereof. The set of customized criteria may include and/or take into account of, for example, an industry criterion, a geographic criterion, a monetary criterion, a political criterion, a severity criterion, an urgency criterion, a subject matter criterion, a topic criterion, a set of named entities, and combinations thereof.

In one aspect of the present invention, the risk-identification-algorithm 140 may be based upon a set of source ratings. As used herein, the phrase “source ratings” refers to the rating of sources, for example, but not limited to, relevance, reliability, etc. The set of source ratings may have a one to one correspondence with a set of sources. The set of sources may serve as a source of information on which the corpus 110, 210 is based. The set of source ratings may be modified based upon an imminent risk, a materialized risk, and combinations thereof.

The method of the present invention may further include transmitting the signal representative of the set of prerequisite risks, transmitting the signal representative of the imminent risk, transmitting the signal representative of the materialized risk, and combinations thereof. Moreover, the present invention may further include providing a web-based risk alerting service using at least one of the signals representative of the set of risks, the signal representative of the imminent risk, the signal representative of the materialized risk, and combinations thereof.

In another aspect of the present invention a computing device 120, as depicted in FIG. 2, may include an electronic memory 150; and a risk-identification-algorithm 140 based, at least in part, on the set of risk-indicating patterns associated with a corpus stored in the electronic memory 150. A processor (not shown) may be used to run the algorithm 140 on the computing device 120. The computing device 120 may include a computer interface 170, which is depicted, but not limited to, a keyboard, for querying the risk-identification-algorithm 140. The computing device 120 may include a display device 160 for receiving a signal from the electronic memory 150 and for displaying risk alerts from the risk-identification-algorithm 140.

In another aspect of the present invention, a computer system 500, as depicted in FIG. 14, is provided for alerting a user of risks. The system 500 may include a computing device 520 having an electronic memory 550 and a risk-identification-algorithm 540 based, at least in part, on the set of risk-indicating patterns associated with a corpus 110 stored in the electronic memory 550. A processor (not shown) may be used to run the algorithm 540 on the computing device 520. The system 500 may further include a user interface 580 for querying the risk-identification-algorithm 540 and for receiving a signal from the electronic memory 550 of the computing device 520 for alerting a user of risks. The user interface 580 may include, but is not limited to, a computer, a television, a portable media device, and/or a web-enabled device, such as a cellular phone, a personal data assistant, and the like.

Generating Entity Risk Profiles (ERPs)

One embodiment of the present inventions provides a computer-based system for generating entity or company risk profiles (ERPs), which profiles may be used to represent a measurement of risk associated with the entity and may be used in predicting price directions/movement there from with respect to the entity represented by the ERP. Although systems that identify risks and generate alerts based on such risks are helpful, many financial professionals find it difficult to efficiently process a large number of alerts that may be generated and may perceive excessive alerting as spamming. Also, despite the ability to automatically route these alerts to company or sector analysts, the alerts in such quantities may be difficult to track and digest.

In implementing the invention, one task is to identify and annotate language indicating risk in English prose documents. “Risk” is defined as an event that may happen in the future or that has future consequences and has potentially significant impact, i.e. positive (opportunity) or negative (threat), on the subject entity. “Risk phrases” are text spans that indicate that a certain company faces a certain risk (threat or opportunity). In a first example, “Goldman Sachs reported losses for the most recent quarter” yields negative risks>financial risks, i.e., the negative risk is a financial risk type. In another example, “Experts believe the volcano may erupt again in the near future,” yields negative risks>natural disaster risks. In a further example, “Sluggish demand for houses is keeping property prices subdued,” yields negative risks>market risks>demand risks (2×), i.e., the negative risk is both a market risk type and a demand risk type. In another example, “Analysts expect the merger to lead to efficiency savings,” yields positive risks>savings. In the example, “Yesterday, a man gave Peter a book to read because it was raining,” there is no associated risk identified with the comment.

The annotation implies (1) finding risk phrases, (2) marking up the polarity of the risk phrase, (3) finding company names, (4) attaching the risk phrases to companies that face them where possible. The process may be described as follows. Step 1—find risk phrases: mark up all text spans as a risk phrase indicative of either positive and/or negative risks. Step 2—decide on polarity (decide between positive negative risk) for each risk phrase. For instance, if the text span expresses a negative risk, mark the polarity of the span as “−1” (negative). If the text span expresses a positive risk (opportunity), mark the polarity for the span as “+1” (positive). As discussed above, the ERP system is based on a taxonomy and is adapted to learn from content accessed, e.g., via the Web, terms and phrases that connotes a negative (−) risk. The same approach is applied in the context of positive (+) risks or opportunities. Seed words or terms or phrases may be used for both learning negative and positive risk imparting terms found in textual content, i.e., different seed words learn different polarities (−/+). In a third step, find company (and other entity) names. Examine text contained in document(s) and mark up all company names, organization names and country names. For instance, for countries only if read as geo-political entity, e.g. “Turkey” in the statement “Turkey tries to keep inflation under control.” However, “Spain,” in “Spain's weather lured many tourists to the Costa Brava again,” would not be interpreted as geo-political. In step four, link risk phrases to company names and for each risk phrase. Determine the most likely company that could face the risk expressed in this risk phrase, if any, and mark up the connection.

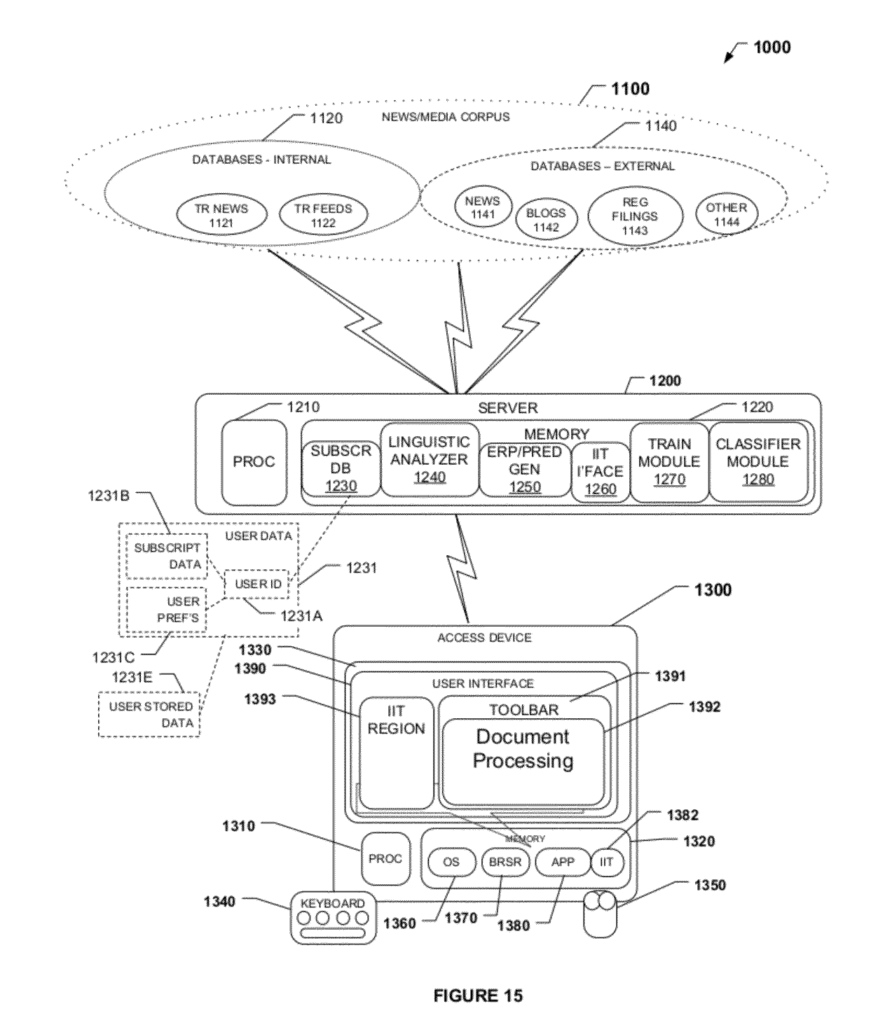

In one implementation, with reference to FIG. 15, the present invention provides an Entity-specific Risk Profile Generation System (ERPGS or “ERP system”) 1000 in the form of a news/media and other content analytics system for information extraction and is adapted to automatically process and “read” news stories and content from news, governmental filings, blogs, and other credible media sources, represented by news/media corpus 1100. Server 1200 is in electrical communication with corpus 1100, e.g., over one or more or a combination of Internet, Ethernet, fiber optic or other suitable communication means. Server 1200 includes a processor module 1210, a memory module 1220, which comprises a subscriber database 1230, a linguistic analyzer 1240, ERP module 1250, a user-interface module 1260, a training/learning module 1270 and a classifier module 1280. Processor module 1210 includes one or more local or distributed processors, controllers, or virtual machines. Memory module 1220, which takes the exemplary form of one or more electronic, magnetic, or optical data-storage devices, stores machine readable and/or executable instruction sets for wholly or partly defining software and related user interfaces for execution of the processor 1210 of the various data and modules 1230-1280.

Quantitative analysis, techniques or mathematics, such as linguistic analyzer module 1240 and entity risk scoring and ERP generation module 1250, which may also include predictive behavior determination capabilities, in conjunction with computer science are processed by processor 1210 of server 1200 to arrive at ERPs and, optionally, process predictive patterns to model the level of risk associated with an entity and associated financial securities (stocks), and may include generating a predictive movement of the entity's stock price and recommended action, e.g., buy, sell or hold, predicted stock price, predicted price range over time. The ERPGS 1000 automatically accesses and processes news stories, filings, and other content and applies one or more computational linguistic techniques and resulting risk taxonomy against such content. The ERPGS identifies risks and entities and associates risks with particular entities and scores the identified risks to generate an entity-specific risk profile (ERP) data structure. The ERPGS may further process information, including historical trading information, historical risk information, and historical ERP and risk scores to arrive at an anticipated or predictive behavior of stock price and other investment vehicles. The ERPGS 1000 leverages traditional and new media resources to provide a risk-based solution that expands the scope of conventional tools to provide an enhanced analysis data structure for use by financial analysts, investment managers, risk managers and others.

The ERPGS 1000 may receive as input via news media source 1141, blogs 1142, and governmental or regulatory filings source 1143 of news/media corpus 1100 content from the following exemplary content sources: news websites (reuters.com, bloomberg.com, Thomson Financial, etc); websites of governmental agencies (epa.gov); websites of academic institutes, political parties (mcgill.ca/mse, www.democrats.org etc); online magazine websites (emagazine.com/); blogging websites (Blogger, ExpressionEngine, LiveJournal, Open Diary, TypePad, Vox, WordPress, Xanga etc); social and professional networking sites (e.g., LinkedIn); and information aggregators (Netvibes, Evri/Twine, etc). The invention may optionally employ other technologies, such as translators, character recognition, and voice recognition, to convert content received in one form into another form for processing by the ERPGS. In this manner, the system may expand the scope of available content sources for use in identifying and scoring risks.

The ERPGS 1000 of FIG. 15 includes risk scoring and ERP generating module 1250 adapted to process news/media information received as input via news/media corpus 1100 and to identify risks associated with particular entities and arrive at risk scoring in processing news/media items related to one or more companies. ERP and risk score may be derived from computational linguistics and define or represent credible statements identified from, e.g., an article. The risk, as discussed in more detail below, will be interpreted as either positive, negative or neutral, and assigned respective polarizations, e.g., scores of +1, −1, and 0. The score may be derived from text and/or metadata from news/media and may apply a predefined or learned lexicon-based risk taxonomy or pattern to the processed text/metadata. The ERPGS 1000 may include a training or learning module 1270 that analyzes past or archived news/media, and may include use of a known training set of data, and may consider historical stock price information, especially in comparison with historical “facts” or events. In this manner the ERPGS may be adapted to build a model to predict stock behavior given certain types of news or events.

In one exemplary implementation, the ERPGS 1000 may be operated by a traditional financial services company, e.g., Thomson Reuters, wherein corpus 1100 includes internal databases or sources of content 1120, e.g., TR News and TR Feeds, reuters.com, etc. For example, Thomson Reuters sources as the internal database may include legal sources (Westlaw), regulatory (SEC in particular, controversy data, sector specific, Etc.), social media (application of special meta-data to make it useful), and news (Thomson Reuters News) and news-like sources, including financial news and reporting. In addition, corpus 1100 may be supplemented with external sources 1140, freely available or subscription-based, as additional data points considered by the ERPGS and/or predictive model. Hard facts, e.g., explosion on an oil rig results in direct financial losses (loss of revenue, damages liability, etc.) as well as negative environmental impact and resulting negative greenness score, and sentiment, e.g., quantifying the effect of fear, uncertainty, negative reputation, etc., are considered as factors that drive green scoring and/or composite environmental or green index. The results may be used to enhance investment and trading strategies (e.g., stocks and other equities, bonds and commodities) and enable users to track and spot new opportunities and generate Alpha. The news/media sentiment analysis 1250 may be used in conjunction with green scoring module 1240 to provide green scoring to drive informed trading and investment decisions.

In one example of how the ERPGS may be further extended to process additional information, upon identifying in content obtained via TR News 1121 or TR Feeds 1122, e.g., legal reporter (e.g., Westlaw), that a company “Newco” has successfully enforced a patent (“XYZ” patent), the ERP may be updated to include as a positive risk “patent success.” This risk represents the potential for future successful efforts in further enforcing the patent against other competitors or in accounting for potential future royalties and revenues or increased margins. In presenting this risk to users, the “patent success” risk may include a link to the content from which the risk was derived.

Taking this a step further, in light of the previously referenced internal database-sourced mention concerning highly successful litigation by Newco in enforcing patent XYZ against one or more competitors, the ERP system may include additional capabilities to explore further risks associated with this principal risk. For example, external databases 1140 may include as a source the LinkedIn professional networking site and the system may include technology for accessing and extracting postings at the site. For example, the system may identify a personal account at the LinkedIn service as associated with an employee “Employee” of Newco. In addition, external databases 1140 may include USPTO database of issued patents and the system may identify patent XYZ as being owned by Newco, e.g., assignment recordation database. (In addition, this confirms the legitimacy of the original article that claimed ownership in the XYZ patent by Newco) The system may recognize that patent XYZ names Employee as sole inventor on this and related patents. The ERPGS may recognize a posting at Employee's LinkedIn account that he is no longer an employee of Newco and further that he is now an employee of a competitor of Newco. The EPRGS may score this as a negative risk, e.g., −1, for Newco (loss of key employee associated with successful patent/technology/product) and a positive risk, e.g., +1, for Newco's competitor (acquiring key employee from competitor). Now the ERP system has two additional risks derived from an original risk. These risks may be reflected, respectively, in the ERPs for Newco and its competitor. The ERP system presents users, such as subscribers of the ERP service, with the ERP and may provide links related to each identified risk. In this example, the ERP may include links to one or more of the XYZ patent, the patent assignment, the litigation related sources concerning Newco's successful enforcement of the EYZ patent, and to any source confirming Employee's employment status.

In addition, the ERPGS 1000 may include a classification module 1280 adapted to generate a classification system of entity risks that serves as a classification system for use in risk-based investing and that may be used to create a composite risk index. For example, companies presently assigned an RIC (Reuters Instrument Code), a ticker-like code used to identify financial instruments and indices, may be classified as “risk compliant” (e.g., achieved/maintained a risk score or profile of a certain level and/or duration). In this manner the invention may be used to create a class of risk-RICs for trading purposes. For example, a “Risk Index” may be generated and maintained comprised, for instance, of companies that have attained a risk certification or risk-RIC or the like. A risk index may attract investors interested in low risk companies or sectors.

In one embodiment the ERPGS 1000 may include a training or machine learning module 1270, such as Thomson Reuters' Machine Learning Capabilities and News Analytics, to derive insight from a broad corpus of risk related data, news, and other content, and may be used on providing a normalized risk score at the company (e.g., IBM) and index level (e.g., S&P 500). This historical database or corpus may be separate from or derived from news/media corpus 1100.

In one manner, the corpus 1100 may comprise continuous feeds and may be updated, e.g., in near or close to real time (e.g., about 150 ms), allowing the ERPGS to automatically analyze content, update ERPs based on “new” content, and generate trade (e.g., buy/hold/sell) signals in close to real-time, i.e., within approximately one second. However, the wider the scope of data used in connection with the ERPGS, the longer the response time may be. To shorten the response time, a smaller window/volume of data/content may be considered. The ERPGS may include the capability of generating and issuing timely intelligent alerts and may provide a portal allowing users, e.g., subscription-based analysts, to access not only the ERP and related tools and resources but also additional related and unrelated products, e.g., other Thomson Reuters products.

The ERPGS 1000, powered by linguistics computational technology to process news/media data and content delivered to it, analyzes company-related news/media mentions to track risk over time. The quantitative and qualitative risk components provided by the ERPGS 1000 may be used in market making, in portfolio management to improve asset allocation decisions by benchmarking portfolio risk exposure, in fundamental analysis to forecast stock, sector, and market outlooks, and in risk management to better understand abnormal risks to portfolios and to develop potential risk hedges.

Content may be received as an input to the ERPGS 1000 in any of a variety of ways and forms and the invention is not dependent on the nature of the input. Depending on the source of the information, the ERPGS will apply various techniques to collect information relevant to the risk scoring. For instance, if the source is an internal source or otherwise in a format recognized by the ERPGS, then it may identify content related to a particular company or sector or index based on identifying field or marker in the document or in metadata associated with the document. If the source is external or otherwise not in a format readily understood by the ERPGS, it may employ natural language processing and other linguistics technology to identify companies in the text and to which statements relate.

The ERPGS may be implemented in a variety of deployments and architectures. ERPGS data can be delivered as a deployed solution at a customer or client site, e.g., within the context of an enterprise structure, via a web-based hosting solution(s) or central server, or through a dedicated service, e.g., index feeds. FIG. 15 shows one embodiment of the ERPGS as a News/Media Analytics System comprising an online information-retrieval system adapted to integrate with either or both of a central service provider system or a client-operated processing system, e.g., one or more access or client devices 1300. In this exemplary embodiment, ERPGS 1000 includes at least one web server that can automatically control one or more aspects of an application on a client access device, which may run an application augmented with an add-on framework that integrates into a graphical user interface or browser control to facilitate interfacing with one or more web-based applications.

Subscriber database 1230 includes subscriber-related data for controlling, administering, and managing pay-as-you-go or subscription-based access of databases 1100. In the exemplary embodiment, subscriber database 1230 includes one or more user preference (or more generally user) data structures 1231, including user identification data 1231A, user subscription data 1231B, and user preferences 1231C and may further include user stored data 1231E. In the exemplary embodiment, one or more aspects of the user data structure relate to user customization of various search and interface options. For example, user ID 1231A may include user login and screen name information associated with a user having a subscription to the ERP/risk scoring service distributed via ERPGS 100.

Access device 1300, such as a client device, may take the form of a personal computer, workstation, personal digital assistant, mobile telephone, or any other device capable of providing an effective user interface with a server or database. Specifically, access device 1300 includes a processor module 1310 including one or more processors (or processing circuits), a memory 1320, a display 1330, a keyboard 1340, and a graphical pointer or selector 1350. Processor module 1310 includes one or more processors, processing circuits, or controllers. Memory 1320 stores code (machine-readable or executable instructions) for an operating system 1360, a browser 1370, and document processing software 1380. In the exemplary embodiment, operating system 1360 takes the form of a version of the Microsoft Windows operating system, and browser 1370 takes the form of a version of Microsoft Internet Explorer. Operating system 1360 and browser 1370 not only receive inputs from keyboard 1340 and selector 1350, but also support rendering of graphical user interfaces on display 1330. Upon launching processing software an integrated information-retrieval graphical-user interface 1390 is defined in memory 1320 and rendered on display 1330. Upon rendering, interface 1390 presents data in association with one or more interactive control features.

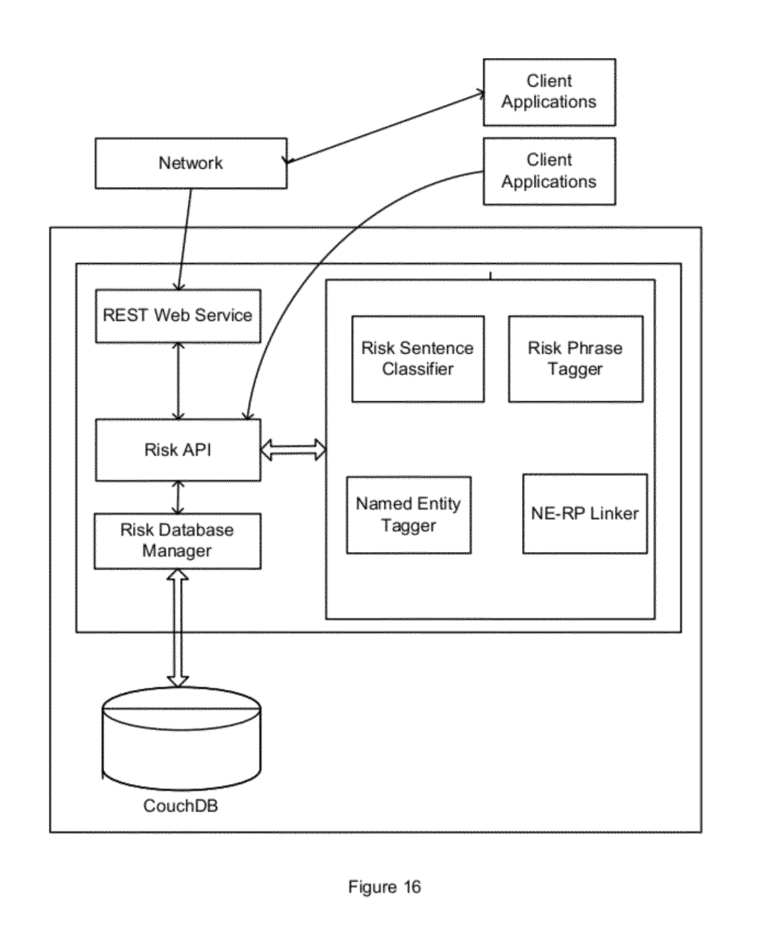

FIG. 16 represents a further exemplary embodiment of the ERP system of the present invention. Client applications can either access the ERP service as a REST Web service over the network, or (for reduced latency) via a Java risk API if client application and server run on the same machine. In this particular embodiment, a risk database manager drives instances of CouchDB (http://couchdb.apache.org/), which is used to store risk annotations. CouchDB provides excellent scalability and replication properties, and the database manager does not work as an abstraction layer; rather, CouchDB specific-properties are heavily utilized, including the built-in MapReduce capabilities. The system operates in one of two modes: normally, a real time news feed is consumed over the network. Alternatively, it can read an archived news collection from the file system in evaluation mode. Incoming news get processed as follows: named entities get tagged using the OpenCalais 4.0 (http://opencalais.com) system. In a pre-processing step, a simple binary risk sentence classifier decides whether any given sentence may contain risk-indicative language on the sentence level or not, based on features like TF, in-window co-occurrence of word pairs, and pointwisde mutual information. A risk phrase tagger tags those sentences using trie-based lookup that were classified as risk-bearing by the risk sentence classifier, whereas the other ones are skipped. The risk phrase tagger's trie is populated with a risk type taxonomy induced using the method described hereinabove. A named entity-risk phrase linker component links the risk phrases with the companies that are exposed to the respective risks based on textual proximity. The risk database manager records each identified company-risk type pair with metadata such as its origin and character offset pair. A set of MapReduce functions implemented in JavaScript are executed inside CouchDB to construct company risk profiles (CRPs) on-the-fly. CRPs aggregate all instances of the same risk type if they could be linked to the same company. Raw counts can be smoothed using k-day moving average to eliminate outlier (with a sliding window width of w=30). Both Generic Risk and Idiosyncratic Risk are aggregated over all absolute opportunity and threat counts, respectively, i.e. they are kept separate. Self Trend is computed by bucketing risk counts across all risk types daily. Peer trend is normalized self trend over the sum or average of the industry risk. In addition, sector-based normalization may be used.

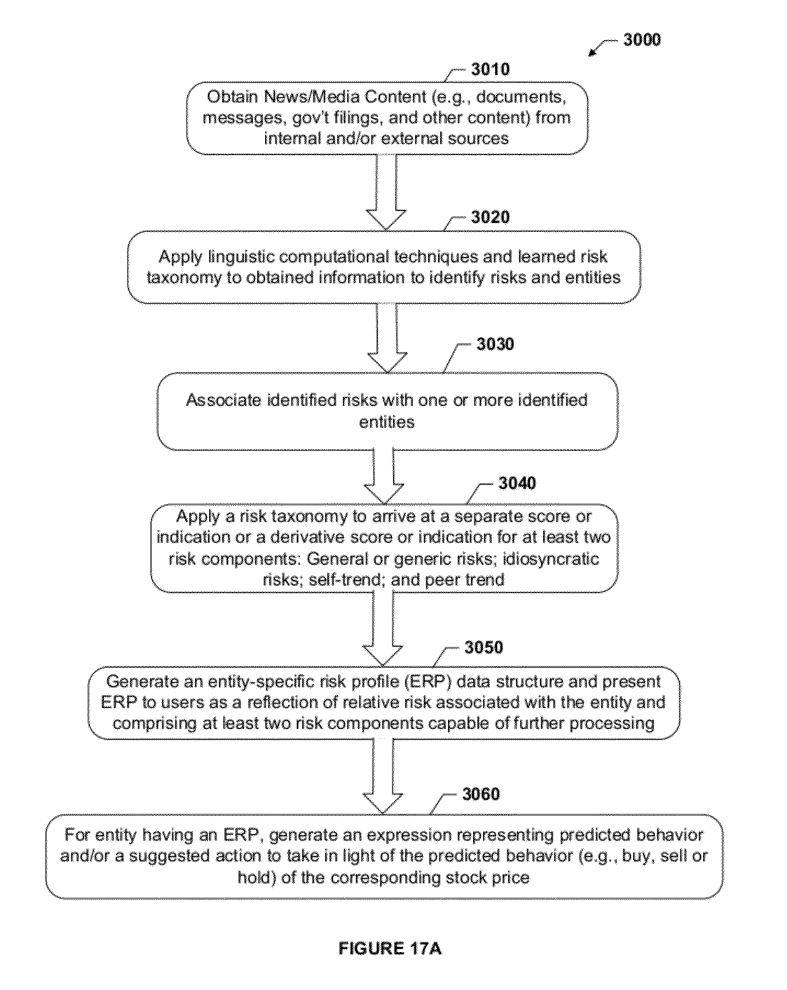

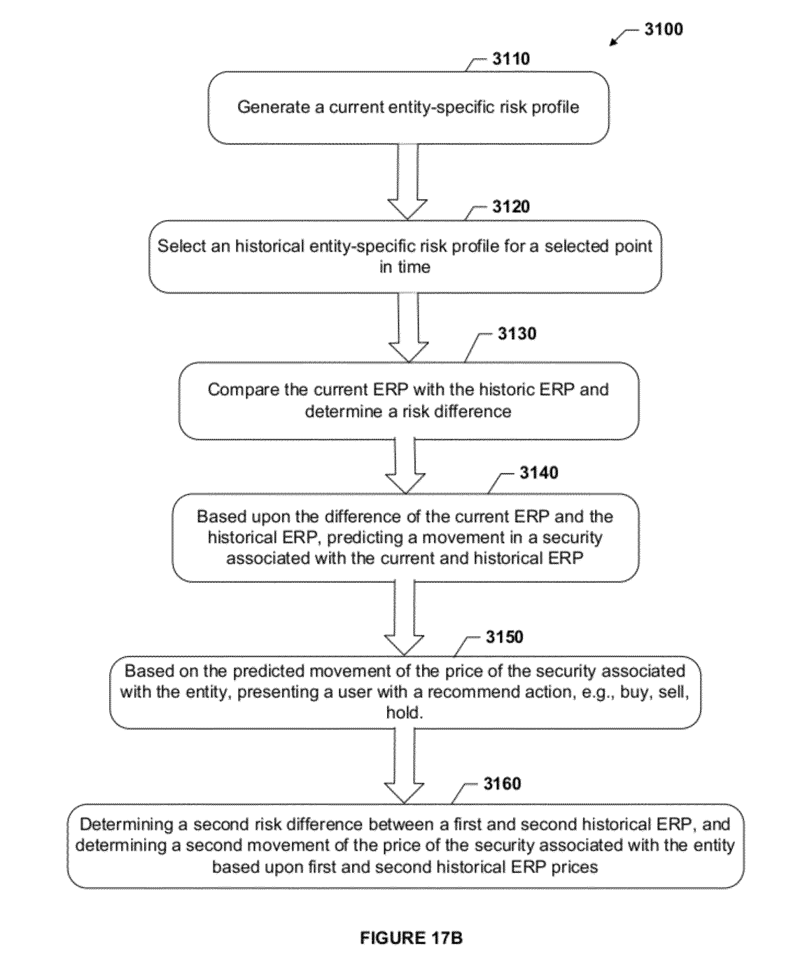

In one exemplary method of the present invention, and with reference to FIG. 17A, a method for generating an ERP 3000 is illustrated as follows. Initially, at step 3010, the ERP system obtains information and content of interest from credible news/media sources (news feeds, blogs, websites, etc.) from internal or external sources. At step 3020 the ERP system applies linguistic computational analysis and learned risk taxonomy to the obtained information from step 3010 to identify risks and entities referenced or mentioned in the content. At step 3030, the ERP system associates risks with one or more entities identified in step 3020. At step 3040, the system applies a risk taxonomy to arrive at a separate score or indication or a derivative score or indication for at least two risk components: General or generic risks; idiosyncratic risks; self-trend; and peer trend. At step 3050, the system generates an entity-specific risk profile (ERP) data structure and presents the ERP to users as a reflection of relative risk associated with the entity and comprising at least two risk components capable of further processing. At step 3060, for an entity having an ERP, generate an expression representing predicted behavior and/or a suggested action to take in light of the predicted behavior (e.g., buy, sell or hold) of the entity's corresponding stock price.

In another exemplary method of the present invention, and with reference to FIG. 17B, a method for predicting a movement of a price of a security based at least in part on changes in risk profile 3100 over time is illustrated as follows. Initially, at step 3110, following the steps as described above with respect to FIG. 17A, the ERP system generates a current entity-specific risk profile. At step 3120, a user enters a selection of an historical ERP for a specific point in time. At step 3130, the ERP system compares the current ERP with the historic ERP and determines a difference. At step 3140, the system, based upon the difference of the current ERP and the historical ERP, predicts a movement in a security associated with the current and historical ERP. The movement may be a movement up or down of a stock price (security) of the entity and may be in terms of absolute value. In one alternative, and especially for entities having a short historical window of data, the system may compare a relative ERP of a similarly situated entity, e.g., competitor or entity in the same sector or industry as the subject entity, in making the comparison. At step 3150, the system, based on the predicted movement of the price of the security associated with the entity, presents a user, such as a financial analyst, with a recommend action, e.g., buy, sell, or hold. At step 3160, determining a second risk difference between a first and second historical ERP (e.g., the first historical ERP may be a historical ERP of the entity and the second historical ERP may be a historical ERP other than one associated with the entity (e.g., a historical ERP for an industry or sector related to the entity), and determining a second movement of the price of the security associated with the entity based upon first and second historical ERP prices. The first and second historical ERP prices being the respective price of the security at the point in time associated with the first and second historical ERPs.

Further to the above description of the method of FIG. 17B, the predicted movement of the security is transmitted to a user, such as a financial analyst, fund manager or investment manager, for consideration in making decision, e.g., to buy or sell or hold the security. The ERP system, or related financial services delivery system or provider, may further consult a database of users to determine a set of users to which to transmit a communication or alert concerning the predicted movement of the security. For instance, an investment manager may have a profile or account set up with the ERP system or related system. Such system may create and maintain a record associated with that investment manager and with which is associated, e.g., by way of a database, a list of securities of interest to that particular investment manager. The record may further include an industry or sector of interest such that all ERPs and communications concerning predicted movement of securities included in such sector or industry are automatically forwarded, presented or otherwise made available to that investment manager. The system may have this in a fee-based structure and may present the investment manager with potential items of interest for which he may select for delivery or access. The system may further identify potential securities of interest based on the set of securities associated with the investment manager's account or record.

Further, the current entity-specific risk profile may comprise one or more of: a. an operational risk indicator; b. a legal risk indicator; c. a markets risk indicator; d. a financial risk indicator; e. a set of idiosyncratic risk information; and f. a set of trend information. Further, the set of trend information may comprise a set of self-trend information and a set of peer trend information. The method described in FIG. 17B may further include the steps of: a. aggregating a set of risk related information; b. generating a categorized set of risk related information by associating the set of risk related information with at least one risk type from a set of risk types, the set of risk types comprising an operational risk type, a legal risk type, a markets risk type, and a financial risk type; and c. electronically storing the categorized set of risk related information.

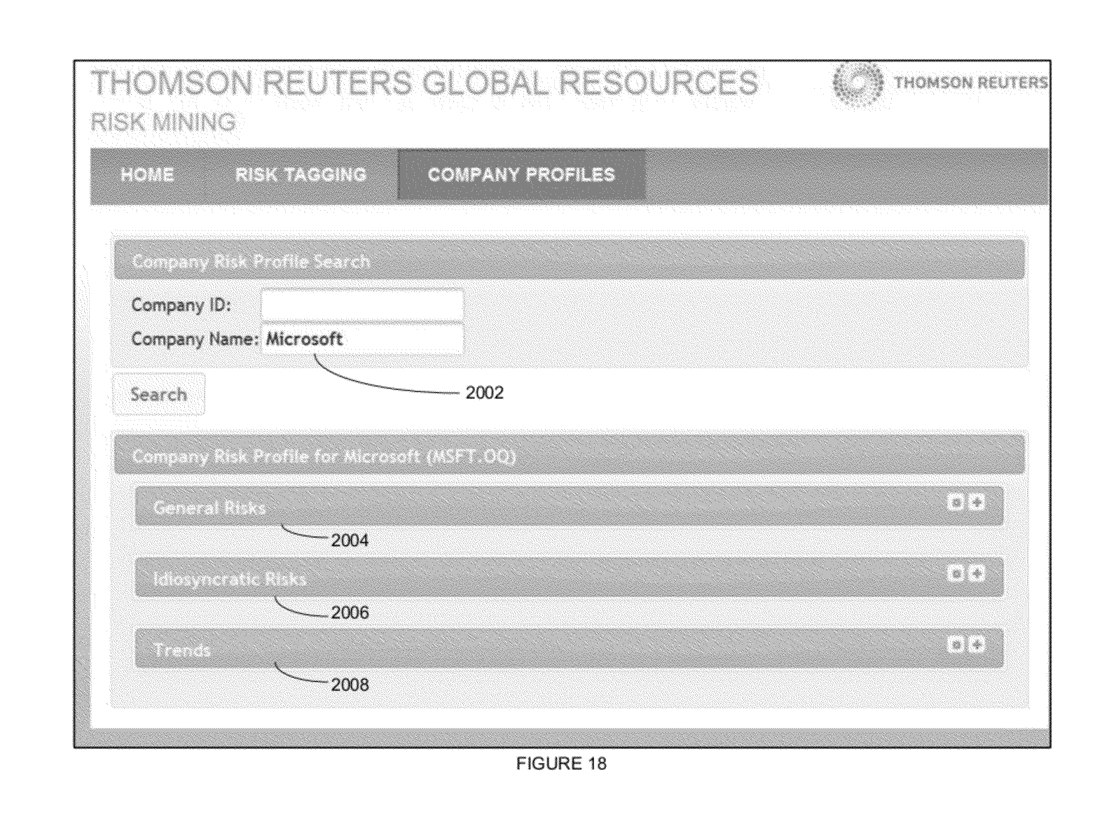

By creating an ERP based on perceived risks appearing in media and other resources, the present invention allows investment managers, industry analysts and chief risk officers to work with an ERP representative of a composite view taking into account all of the information that otherwise may be presented in the form of multiple alerts. With exemplary reference to FIG. 18, the ERP represents the company-specific risk profile and provides a more efficient “quick reference” which analysts may consider in making decisions. In one manner, the ERP is essentially a data structure based upon linguistic analysis wherein the data structure comprises risk parts or components representing risks associated with a company, e.g., Microsoft referenced at 2002. In this example, the four parts are: 1) a set of “General” risks (a set of <risk type; risk exposure indicator>pairs for a set of risk types that are applicable to all companies), referenced at 2004; 2) a set of “Idiosyncratic” risks (a set of <risk type; risk exposure indicator> pairs for a set of risk types that characterize particularly the company under consideration) referenced at 2006; 3) self trends (a set of historic signals and a forecasting trend that relates the company under consideration to its past overall risk exposure); and 4) peer trends (a set of historic signals and a forecasting trend that relates the company under consideration to the past overall risk exposure of its industry peers). The self trends and peer trends are referenced collectively at “Trends” at reference 2008.

The ERP and related processes provide means for analyzing risks and rendering a historical comparison of data to generate predictive firm valuation behavior based on the entity-specific risk profile. After processing vast amount of news, legal, regulatory and other entity-related information based on text, content and context, the ERP system provides investors and those involved in financial services with a risk profile and related analytics that impart meaning to such vast amounts of information and a useful tool to measure likely movement of a company's stock price based on a company's risk profile. ERPs may be used to compare two or more companies to develop a risk-balanced portfolio of companies/securities comprising a fund or portfolio. In this manner, the invention assists fund and other managers in making decisions for the purposes of maintaining portfolios that are balanced or weighted with respect to risk.

Definition of Entity or Company Risk Profile (ERP). Formally, an ERP is a tuple profile that may be represented as (GenericRisk; IdiosyncraticRisk; SelfTrend; PeerTrend). General Risk set or “GenericRisk” is a set of (riskType;riskScore) tuples where riskType E LegalRisks; OperationalRisks; FinancialRisks; and MarketRisks. Idiosyncratic risk set or “IdiosyncraticRisks” is a set of (riskType; riskScore) tuples. The small and closed set GenericRisk (|GenericRisk|=4 for all entities) permits easy comparison of general risks across individual companies (using risk types that are common to all companies, and where risk counts are expected to constitute large numbers, at least for big and popular companies) or company portfolios. The open-ended nature of the IdiosyncraticRisks set, on the other hand, permits easy analysis of “black swan” type risks (their counts may be few or one, which is too small to carry out any kind of statistical processing, but the fact that they are present is very important qualitative indicator of risk. Two types of trends may be considered. “SelfTrend” is a time series set of h tuples (time stamp; risk score), which define a time series (rₜᵢ) of the company's historic (past), aggregated (across weighted risk types), normalized (based on company's own past). If company Bucket(c, t0)=Σₜ₌ₜ₀ riskPhraseCountₜ(c, t) is the sum of all counts of risk phrase occurrences across all risk types (i.e., all generic and all idiosyncratic risk instances) linked to company c for time t, then SelfTrend(c, t)=companyBucket(c, t). “PeerTrend” is a set of h tuples (timestamp; riskscore), which define a time series (rₜᵢ) of the company's historic, aggregated, normalized (based on other companies in the same industry as the company under consideration) and smoothed risk scores: industryBucket(c, t) the sum of all risk phrase occurrences counts linked to companies that belong to industry I at time t. Then we can define PeerTrend(c,I,t)=companyBucket(c,t)/(industryBucket(I,t)−companyBucket(c,t)).

The derivative of the most recent part of both trends can be used for forecasting future trends based on past behavior (which we call SelfForecast and PeerForecast, respectively). FIG. 18 summarizes the ERP in visual form. A set of N companies P=C₁, . . . , C_{N} is called a portfolio P. The portfolio could be a set of companies an analyst follows professionally (e.g., all large toy retailers in the U.S., all banks on the Cayman Islands, all metals commodity traders in Switzerland) or it may be a set of companies that an investment manager is interested in because he or she has invested in financial securities pertaining to the companies. The notion of the risk profile as applied to a portfolio is of paramount importance to ensure diversification. The portfolio risk weights for P may be defined as: W_{P}=w^{r} as a matrix |P|×|R|, which contains weights for each of the |R| risk types encountered in any of the portfolio companies in Portfolio P. (rₜ)=Σ_{c}εP.

Predicting a selftrend may be represented as SelfTrendForecast(c, h(c)) and may take into account the historic time series. Known methods such as autoregressive moving average (ARMA or σARMA) model, autoregressive integrated moving average (ARIMA) model, exponential smoothing and/or Gaussian smoothing may be used to mitigate or eliminate outliers and to smooth the signal to avoid material changes to the trend curve.

Population of Company Risk Profiles. A company risk profile database can be populated given a classifier that (1) identifies text spans as risk phrase mentions and (2) classifies these instances of risk-indicative language by risk type, given a taxonomy. This task can be carried out by rule-based methods, machine learning based methods or a hybrid approach. In this manner, the ERP system combines a taxonomy-based approach similar to (anonymized) and combine it with a risk sentence classifier, which classifies sentences as containing threats (negative risks, to use a term from risk management) or opportunities (positive risks). The term polarity is used to distinguish positive from negative risks. Although some terminology is common to and used with sentiment analysis, the ERP system is directed to addressing a different problem, i.e., risk exposure (e.g., “a volcano eruption has been predicted in Iceland for a couple of years”) is different from subjective affective state (e.g., “Bob hates Microsoft products”).

Both Generic Risk and Idiosyncratic Risk are aggregates over all absolute opportunity and threat counts, respectively. Self Trend is computed by bucketing risk counts across all risk types daily. We compute w-day moving averages with sliding window widths of w. For example window widths used may be w=7, 30, 200 days. The invention is not limited to the number of window widths used or the particular number of days for any such window width.

Evaluation of Risk Mining and Utility—Component-based Evaluation. Both the weakly-supervised risk type taxonomy induction step and the supervised risk sentence classification step can be evaluated intrinsically, i.e., by comparing it against a gold standard. In one manner, the invention may be based on reporting of Precision (P), Recall (R) and their harmonic mean (F1) with automatic methods implemented as computer programs and human-annotated reference data.

Task-Based Evaluation—VIX. In the context of implementing the present invention, several extrinsic evaluation methods may be considered. An application of the novel computations of company risk exposure expressed herein could be used to support algorithmic trading. While different, this may be compared with the way that sentiment has been used in the past (sentiment reflects a subject's individual affective state, e.g., “I just hate Windows!”). In contrast, the present invention is risk-based, where risk focuses on objective exposure to future positive or negative events that impact a company, e.g., “volcano eruptions in Iceland may affect air traffic”). While natural disasters such as earthquakes and volcano eruptions have present day effects, a litany of potential risks and effects may or may not come to fruition. Existing proxies for risk development over time, notably include the VIX ( )CBOE:2012:online, also known as the “Fear Index”, which can be used to test for correlation. One shortcoming of such proxies is that they cannot be used to test and confirm aspects of risk that are not already included in existing signals, which would arguably be most valuable.

CDS Spreads. A second signal to correlate the aggregated risk signal with is using CDS spreads as a proxy for risk. A credit default swap (CDS) is an agreement that the seller will compensate the buyer in the in case of default (breaking a contractual loan repayment agreement). CDs are bought with respect to a reference company, in which the buyer may or may not have an interest. A CDS spread is the premium paid by the buyer. Spreads can be used to track the risk associated to reference entities in the eyes CDS buyers/sellers.

KL-divergence and Granger causality. Relative entropy or Granger causality or can be used to assess whether a signal contains additional information over another. The former works on probability distributions, whereas the latter can directly be applied to time series to test whether given a first time series Xₜ, a second time series Yₜ would helps forecasting a third, target time series Zₜ or not.

The present invention represents the first account of entity risk profiles (ERPs), a new data structure to capture an organizations exposure to various types of risk. ERPs represent current snapshots, historic data as well as future trends. ERPs also include both qualitative risk information and quantitative risks information (normalized risk type mention frequencies). Whereas risk tagging by itself can serve as a reading aid, news and other content are produced at a rate that calls for software assistance, the ERP and related analysis and tools provides an automated aggregation and visual presentation of risks associated with an entity and can serve as a useful surrogate for a task that is no longer possible for humans to carry out comprehensively and consistently without such tool support. The present invention may be used to enable risk management research to move towards employing computer-aided risk identification to anticipate and better mitigate future crises and to broaden risk research to move from purely numeric signals more towards exploiting textual evidence.

In implementation, risk mining may include applying Web mining and information extraction to learning a taxonomy of risk types with little supervision. As discussed above, linguistic patterns are deployed with modifications to determine risk types in an iterative way, e.g., risk such as financial risk type. The data may then be “stuffed” back into an original query pattern. For example, additional more specific terms, e.g., “financial risk,” may be arrived at by building from more general terms, e.g., “risk.” One manner of achieving this building of terms is by use of an iterative approach using Hearst pattern induction. The system learns to take action upon encountering these terms in a new document. The system may issue alerts or take other action, e.g., sending email based on finding words in new document. To avoid the problem of overwhelming users with high volume of alerts for every risk encountered and identified. The system of the present invention creates an entity-specific risk profile (ERP) for that company thereby providing users with a quick reference to a data structure that takes into account multiple risk types in place of or in addition to a steady stream of discrete alerts. The ERP gives an overview composite of risk exposure for that entity.

For example, British Petroleum (BP) may face one set of risks due solely to the nature of the oil business. The ERP system may be used to measure how much this risk type is discussed in media and the actual effect of such discussions over time on stock price. Accordingly, risks associated with oil business in general may be devalued as compared to specific risks such as an oil rig explosion and resulting oil spill and ecological damage. The ERP system delivers a qualitative representation of risk associated with a company. The risk exposure is largely forward looking, i.e., potential future risk as opposed to an actual materialized event. The ERP system projects the end effect of risk over time by measuring and counting the number of occurrences of terms, e.g., “technology disruption” used in context of digital cameras, as having a potentially negative effect on old-technology-based companies, e.g., companies that are tied to film-based photography (e.g., Kodak). However, the ERP system may also identify this apparently negative risk as a potentially positive risk in that the new technology is also an opportunity for an old technology-based company to enter a new line of products and related services to generate additional revenues at potentially higher profit margins.

Although largely discussed in the context of the entity being a company or industry sector, the ERP processes and ERP profile may be applied in the context of other types of entities, e.g., person such as “politically exposed persons” (PEPs). In the context of an individual person, the ERP system identifies risks to the person, e.g., politician is subject to risks, e.g., loss of election, challenger, expiration of term of office, assassination. In the event of a perceived increase in risk to a person, i.e., physical harm, then a security entity could increase protections for the individual to address the perceived threat.

Because issuing alerts in each and every instance of identifying risk-indicative language in content from a large corpus or database of content makes the review of such a large number of alerts, including strong and weak risk signals, unmanageable. The present invention provides a system that automatically aggregates entity risks and generates an entity-specific risk profile (ERP), for example, from a large corpus of electronic documents. The ERP data structure represents a company's risk exposure as extracted and aggregated from unstructured textual data contained within documents from the corpus. A user, such as a financial analyst, an investment manager, or a risk manager, may then use the ERP data structure to drill down and further analyze the underlying data. The method may be performed by a system designed to receive a large corpus of news and other data and identify risks associated with a specific entity. One form of classifier may be evaluated in terms of P/R/F1 (Precision/Recall/F1 measure) scores as well as an extrinsic evaluation in terms of correlation with the VIX risk index (Chicago Board of Exchange CBOE Volatility Index—an option-based, weighted measure of the implied volatility).

Table 1 illustrates an exemplary Output of the Risk Tagging Service:

TABLE 1
Sample Risk Service Output.

<riskmining:taggedDocument>

<riskmining:tags><riskmining:risktype=″stability″ polarity=″−1″

start=″64″ end= Virgin Money took over the Newcastle-based
<riskmining:risk ref=″null″ type=″credit” <riskmining:risk ref=″null″
type=″long bush war″ polarity=″0″ start=″415″ end=″416” Sir Richard
began a two-day <riskmining:risk ref=″null″ type=″of nationally
significant” “The rebranding of all 75 branches is expected to take about
nine months.
<riskmining:risk ref=″null″ type=″long bush war″ polarity=″0″
start=″712″ end=″713

</riskmining:document>

</riskmining:taggedDocument>

Prior attempts to represent risk usually used a single number to represent risk, e.g., share price (goes up—less risk; goes down more risk). This does not look to a historical based approach to generating a true risk factor. The standard metric for risk is volatility, which is a quantitative way to measure (from statistics, measures whether share price goes up and down a lot, instability, fluctuation, only based on “return” standard deviation of annualized return of an instrument). Another risk measurement is VAR (value at risk), which indicates the value of the stock together with the probability over a certain time horizon that this is not to happen. Both volatility and VAR have in common that they are single scalar numbers, provide no way to separate out components for further analysis, and are not informative in additional detail. Component risk parts provided with the ERP allow a user/analyst to break down the risk profile into constituent parts for further and more particularized analysis. The ERP thereby provides the user with much more flexibility and information to use in analysis.

Although the ERP does have a quantitative aspect in that the number of “mentions” are considered in scoring to arrive at certain parts of the profile, it also provides a qualitative aspect, i.e., the ERP considers not just how often litigation concerning an entity is discussed but also that there is a risk even with a single mention. In this manner, a single mention of a litigation that potentially has highly impactful results to an entity may be interpreted as a possible “Black Swan” event (which is discussed in detail below) that represents a risk that is not likely to happen but if it did come to fruition then it would result in a huge impact on the market. By separately accounting for such rare but potentially highly impactful risks, the ERP provides a tool investors may use to identify high reward/low cost entry or investment. The low cost is due to the low likelihood of occurrence. The assumption is that the world is not “normally” statistically distributive, e.g. linguistic distribution, and quantitative (how many times it is mentioned—many mentions of litigation involving Microsoft).

With regard to this qualitative aspect, normal events included in “General” type risks happen often and individually may have little impact or little surprising impact on an entity or an entity's stock price. In contrast, when a “Black Swan” event does occur, albeit with low frequency, the event has strong impact on the price of the stock. One problem with prior systems is that low frequency events are largely discounted as statistically irrelevant or insignificant and fail to take into account the tremendous disruptive effect they have when they do occur. Idiosyncratic risk types comprise these sorts of rare but specific instances that should be given consideration. The present invention is flexible and can compare companies using only the generic or general risks, but can also compare based on idiosynchratic risks and trends.

The data structure can be used to review portfolio profile—i.e., is the portfolio as a whole comprised of stocks that collectively are high risk. Can apply invention on a fine grained level allowing managers to include some companies with litigation risk and others having low litigation risk to balance portfolio profile. In addition, the ERP system allows investors to apply a risk-based threshold parameter, e.g., if too risky then may lose investment, if not risky enough then returns likely to be low. In this manner the ERP and related services provide an investment tool for investment management and for risk management. Also, a given company can use the invention to determine if the various corporate operations present too great a risk—gives a view of the corporate risk profile.

Computing frequency of certain words such that the ERP system learns taxonomy (discussed above) then uses nodes of taxonomy to determine how often they occur and then build profile. The risks include both technical risk (profit, loss, etc.) and literature risk (mentions that indicate risk). Positive risk (opportunities) and negative risk (risk) are not “sentiment.” Risk has at least some forward looking aspect. Does not exclude the present, can have cascading effect, e.g., tsunami occurred, opens up a broad array of risks that may occur over time. Risk has some speculation, whereas sentiment is current expression of subjective belief.

Competitor relationship, e.g., Thomson Reuters (“TR”) and Bloomberg; Ford Motor Company (“Ford”) and General Motors (“GM”), if something bad happens only to a competitor then that is likely good for the other entities in competition with that entity, e.g., bad for Ford, good for GM, Toyota, etc. Entity can be companies, people (Steve Jobs—may have both effect on company and on person of interest), can be industry, and sector. An entity may be a particular type, e.g., PEP—“politically exposed persons”—very important for journalist's interaction between media and politicians. The ERP system preferably considers only sources the content from which are deemed or determined credible, does not consider sentiment so the source and source material considered should be viewed or determined to be credible. In one manner of operation, the ERP system may only receive content from sources that are pre-determined to be credible. Accordingly, no further determination as to authority is necessary. In another manner, the ERP system may include a means for determining the credibility of a source of content and may use this as a sort of filter to include/exclude information from the corpus. Also, the system may include a means to de-select or discard content initially deemed credible but later found to be less than credible. Credibility does not necessarily mean absolute truth or fact however, e.g., retraction of faulty news story can be taken into account.

The ERP system takes into account trends and other historical information. The ERP system may use weighting techniques in one or more of its process. For instance, historical correlation between risks and stock movement may result in greater weight given to that correlation. Also, the ERP system may employ a “decay” factor, i.e., more recent mentions or risks are given more weight and older risks are given less weight. Also, can look to correlation between actual stock price movement and risk evaluation over time. Time theories, risk signals going up and down versus actual stock movement data. ERP risks may be compiled as if in periodic, e.g., daily, buckets, but can be milliseconds, seconds, hours, etc. Self trend is preferably a number on a particular day.

Peer trend is like self trend and performs further calculation sector (utilities) or industry (energy providers within utilities) computation. Ratio between the self trend and the risk trend of all its industry peers. Can either remove or leave in the entity from the sector/industry group considered in the peer trend. Industry/Sector trend versus “peer” trend.

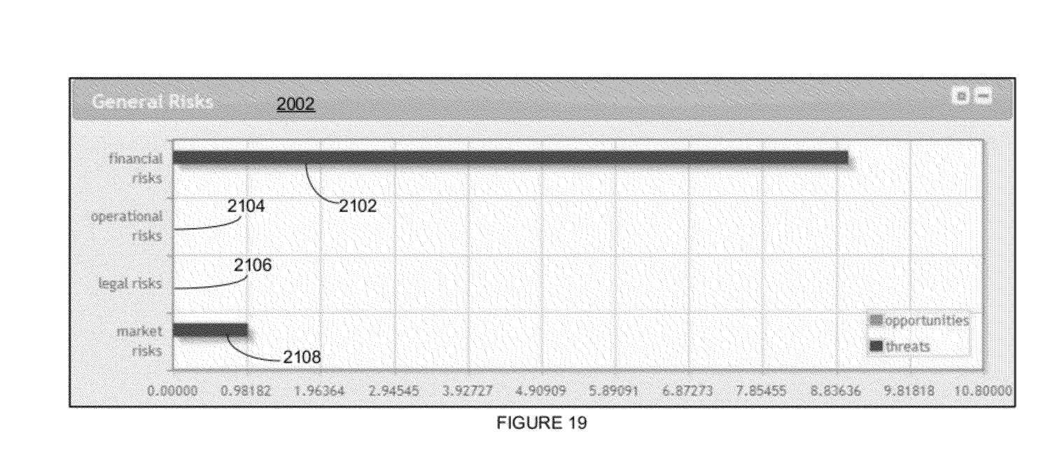

Now with reference to the graphical representation of FIG. 19, General risks 2004 may be comprised of financial risks 2102, operational risks 2104, legal risks 2106, and market risks 2108, and may be represented in scalar form or normalized as desired. General Risks are those risks that are designated to be universal, i.e., they apply to all companies—financial, operational, legal, and market. Typically, all business concerns are exposed to these general risk types. For other types of entities, the defined set of general risk types may be tailored to best represent that entity type, e.g., political figure. In this case, because all companies have these risk types, they get mentioned often, and therefore counts are quite high.

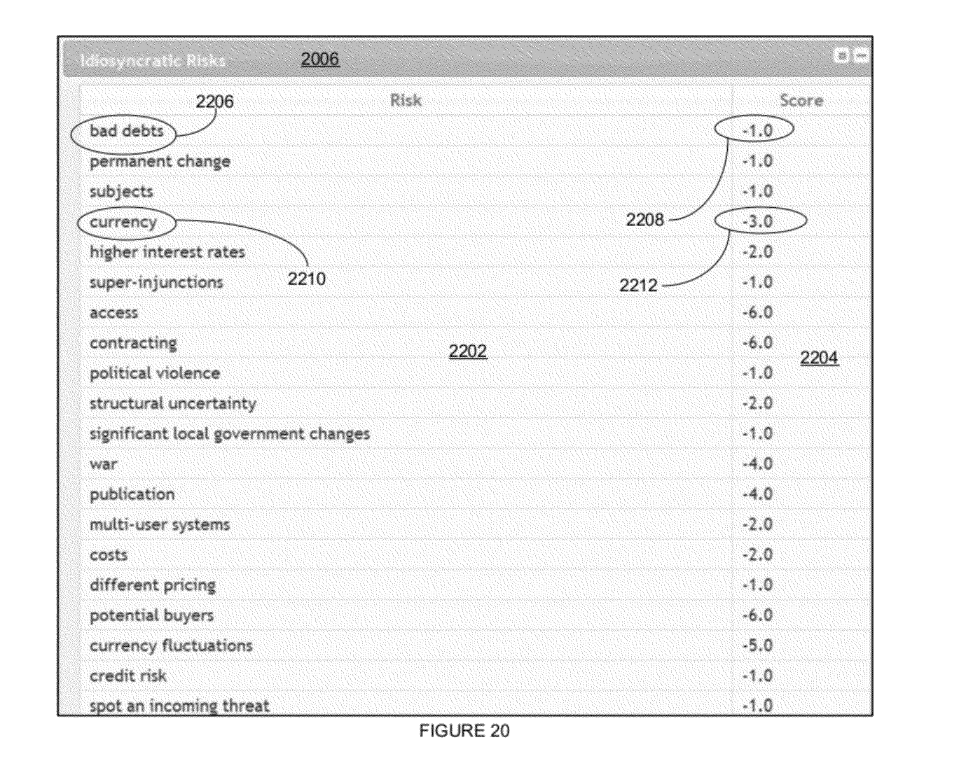

FIG. 20 represents an exemplary set of Idiosyncratic Risks 2006, which generally represent all other non-general or more specific risks. In this example, the set of risks 2202 represent text terms identified and extracted through the ERP process from content sources as being reliable and as being associated with a specific entity and representing risk associated with that entity. In this example, scores 2204 may represent each instance of the idiosyncratic risk mentioned in a content piece. The set 2202 includes the terms “bad debts”, “permanent change”, “currency”, “higher interest rates”, “super injunctions”, etc. In this example, a score is assigned to each idiosyncratic risk, e.g., “bad debts” 2206 received a score of −1.0 2208, and “currency” 2210 received a score of −3.0 2212. The scores may be based on a count of the terms that appear in a corpus of content, e.g., the term currency appeared three times in one or more article, press release, regulatory filing, legal document, or other unit of content included in the corpus or set of content processed by the ERP generating system. Counts may be normalized (e.g., log scale, frequency/popularity, or normalization by means of division be a “normal” value) and smoothed (e.g., autoregressive moving average (ARMA or σARMA) model, autoregressive integrated moving average (ARIMA) model, exponential or Gaussian smoothing). In one manner, the system may determine that the term “currency” represents a negative risk in four instances and represents a positive risk in one instance. In that scenario, the list 2202 may include “currency” twice, once as a negative risk with a score of −4.0 and once as a positive risk with a score of +1.0. In this manner, a financial analyst may separately consider and review only negative risks and/or only positive risks. Although threats and opportunities are preferable processed and expressed separately, they may be compiled collectively. For instance, in one alternative the list may include the term “currency” only once with a composite score for that term of −3.0 (−4.0+1.0=−3.0). Again, an analyst can still review negative and positive risks; however, in this second scenario the term “currency” would only appear as a negative risk with a score of −3.0 rather than a score of −4.0. Scores or scoring may be normalized using any of a number of known methods. This example illustrates how using a multi-component risk profile provides greater analytical robustness and versatility to assist the user, e.g., financial analyst or risk manager, in decision making processes, e.g., investment decisions or managing corporate risk.

Also, terms may be weighted as representing relatively more or less risk based on the linguistic processes used in the ERP process. Idiosyncratic risks may represent risks that are specific to one or a small group of companies and may be considered as terms that are mentioned less frequently in content sources. Idiosyncratic risks may include risks of the sort that are not generally expected. One aspect of idiosyncratic risks is to account for “Black Swan” type events. This is a reference to a risk theory and associated book entitled “The Black Swan: The Impact of the Highly Improbable” authored by Nassim Nicholas Taleb. A Black Swan, named after the rare occurrence of a black swan as compared to the more frequent occurrence of a white swan, is a highly improbable event with three principal characteristics: unpredictability; massive impact; and, after the fact, rationalization that makes its occurrence appear less random, and more predictable, than it actually was. For instance, the astonishing success of the Internet, Facebook, Google are Black Swans, as was the events of “9/11.” The meteoric success of the Internet and its eventual ubiquitous nature opened the way for whole industries and opportunities to form. The Internet has shaped the way people and businesses interact. Offspring from the Internet Black Swan include, for example, the three further Black Swans of Amazon, Google and Facebook. The Internet led to the opportunity to de-localize retail transaction experience by resulting in the opportunity to electronically connect remote potential buyers of products with an electronic retailer, e.g., Amazon. A further result is the increased volume in delivery services resulting from the need to deliver remotely ordered goods—thus another opportunity for entities such as UPS and Federal Express. The vast amount of information and documents available as a result of the Internet and high speed switching and networks led to the opportunity for a company, Google, to develop a public searching tool and associated business model. Likewise, the Internet led to opportunities seized by a number of social networking entities, e.g., Facebook, who had immense and immediate impact. Presently, there exists the problem that these “Black Swan” risk types and their offspring get overlooked because they are not often mentioned in available resources and are thus statistically insignificant. However the Black Swan effect informs that such unpredictable risks can have great impact. This part of the ERP Profile provides a useful qualitative representation or construct concerning an entity's risk exposure by accounting for such risks in the idiosyncratic component of the profile.

In addition, content appearing in a document from the corpus may be identified with multiple entities and may be identified as risks with multiple entities. For instance, an idiosyncratic risk “labor disruption” may be included in a list of such risks, e.g., list 2202 of FIG. 20. The source of the content and identified term “labor disruption” may identify the Ford Motor Company as having an impending disruption in manufacturing due to expiration of a labor contract without successful negotiations for terms to extend the contract. The ERP system identifies the term “labor disruption” as a negative risk associated with the Ford Motor Company and this risk will have a resulting negative effect on that company's ERP. Moreover, the article may mention that General Motors is not subject to “labor disruption” and the ERP system may further identify the term “labor disruption” as a positive risk associated with that entity. Even if General Motors is not mentioned in the article, the ERP system may consider the negative risk of Ford's potential labor disruption as a positive risk for the peer group—automotive sector and/or for the individual constituents of that sector, e.g., General Motors, Toyota, etc. In general, any event, e.g., labor disruption, tsunami, earthquake, war, that has the potential to negatively impact the production capabilities of an entity represents a negative risk to that entity and a positive risk to competitors not facing the same threat. The ERRP system may further include links from the profile and related user interfaces to the content associated with a particular risk to allow an analyst to access the source of the risk for further review and context.

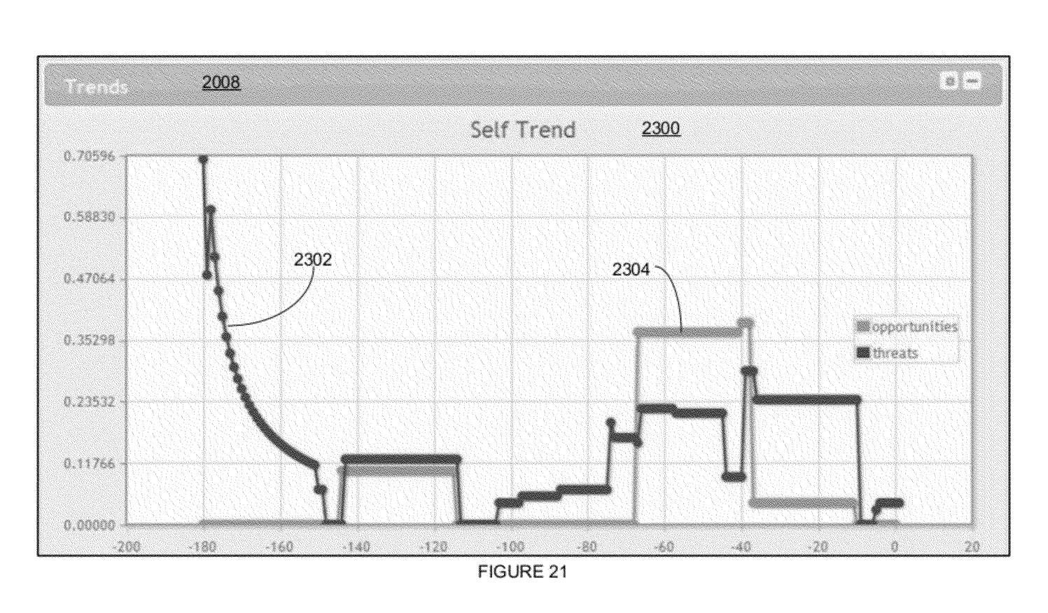

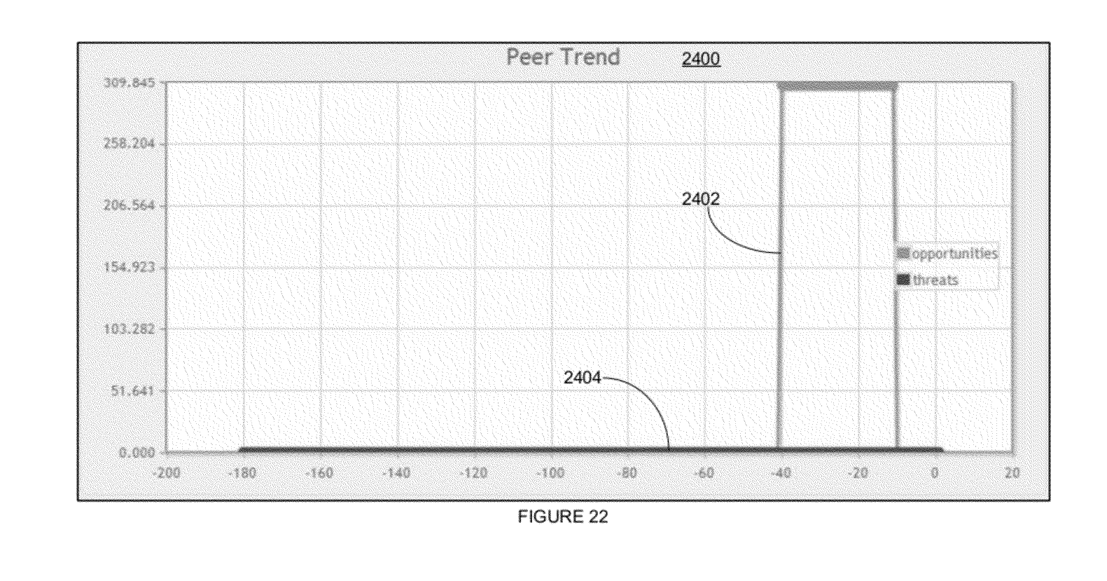

With respect to FIGS. 21 and 22, FIG. 21 is a graphical representation of a Self Trend. In this exemplary embodiment, “Self Trend” represents a time series including the sum of General and Idiosyncratic risk counts or other scoring. In this example the risk counts or scoring are normalized and with a moving average applied to them. For Self Trend, the ERP system considers historical data, in this example data over the preceding 200 days, and normalizes the data against an entity's own past. In this example, the graph represents opportunities/positive risks 2302 and threats/negative risks 2304 identified and quantified from a content collection as being associated with an entity.

FIG. 22 is a graphical representation of a Peer Trend. In this exemplary embodiment, Peer Trend represents a time series including the sum of absolute values of General and Idiosyncratic risk counts or other scoring, i.e., threats and opportunities are dealt with separately. In this example the risk counts or scoring are normalized and with a moving average applied to them. For Peer Trend, the ERP system considers historical data, in this example data over the preceding 200 days, and normalizes the data against the average of the entity's industry or sector peers. In this example, the graph represents opportunities/positive risks 2402 and threats/negative risks 2404 identified and quantified from a content collection as being associated with a peer group. The peer group may or may not include the subject entity. Also, a financial analyst may weigh relative risk exposure associated with a peer group more heavily than a company's self trend in isolation. In any event, the analyst can review this as a separate risk aspect of the entity. This is another example of the robustness and versatility of the multi-component ERP profile of the present invention and its various beneficial uses.

The data used in these examples is using an arbitrary 200-day window using a brief sample of historical data. In operation, the ERP generation system may be connected with a vast content source, e.g., REUTERS real-time news feed, for representation of a significant amount of collected and analyzed data. In implementation, e.g., a customer GUI, the system may hide the numbers in the Idiosyncratic Risks section.

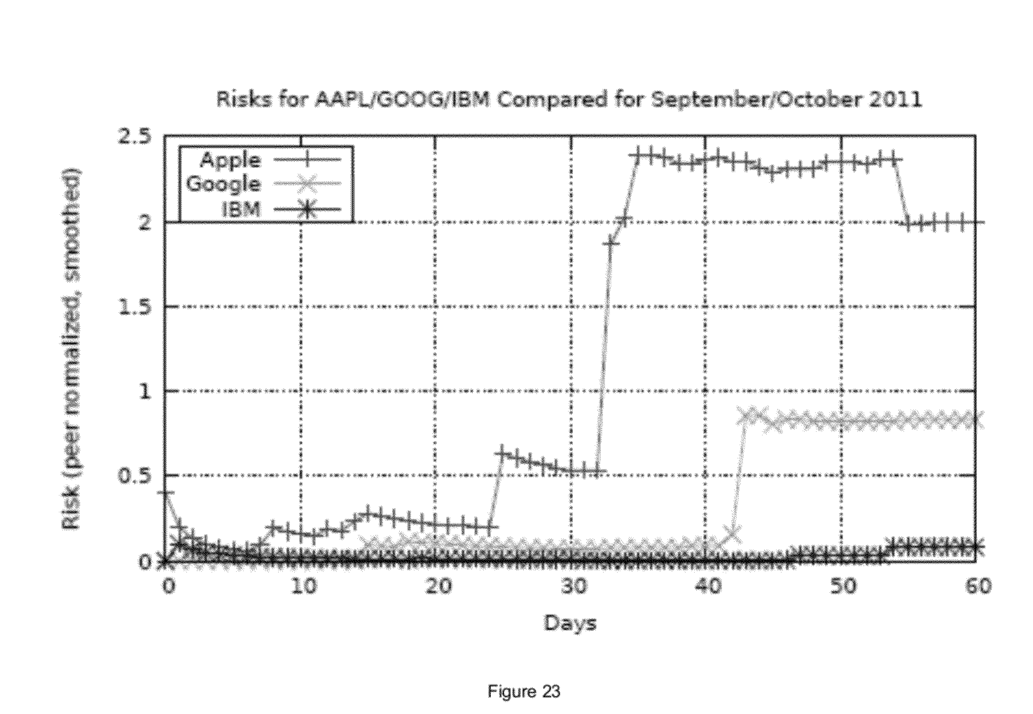

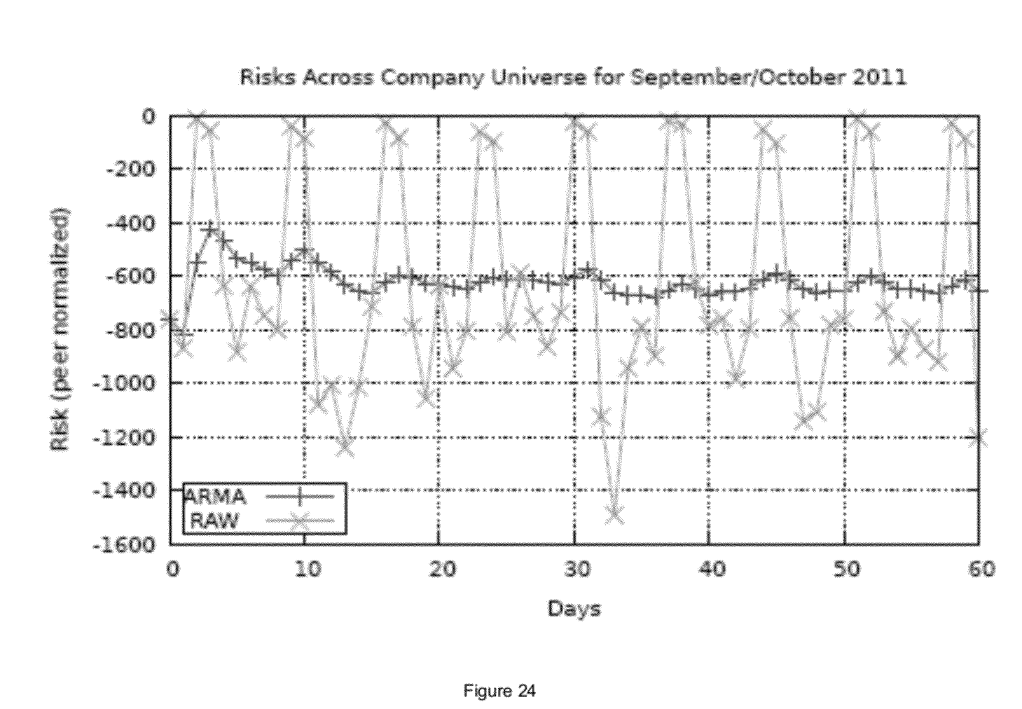

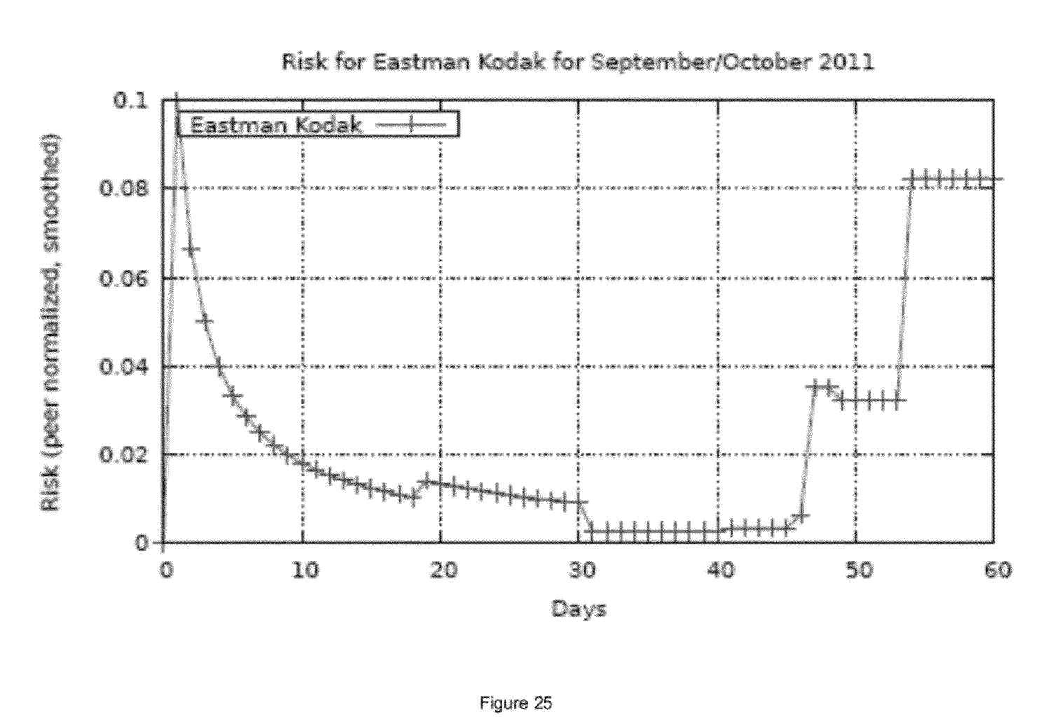

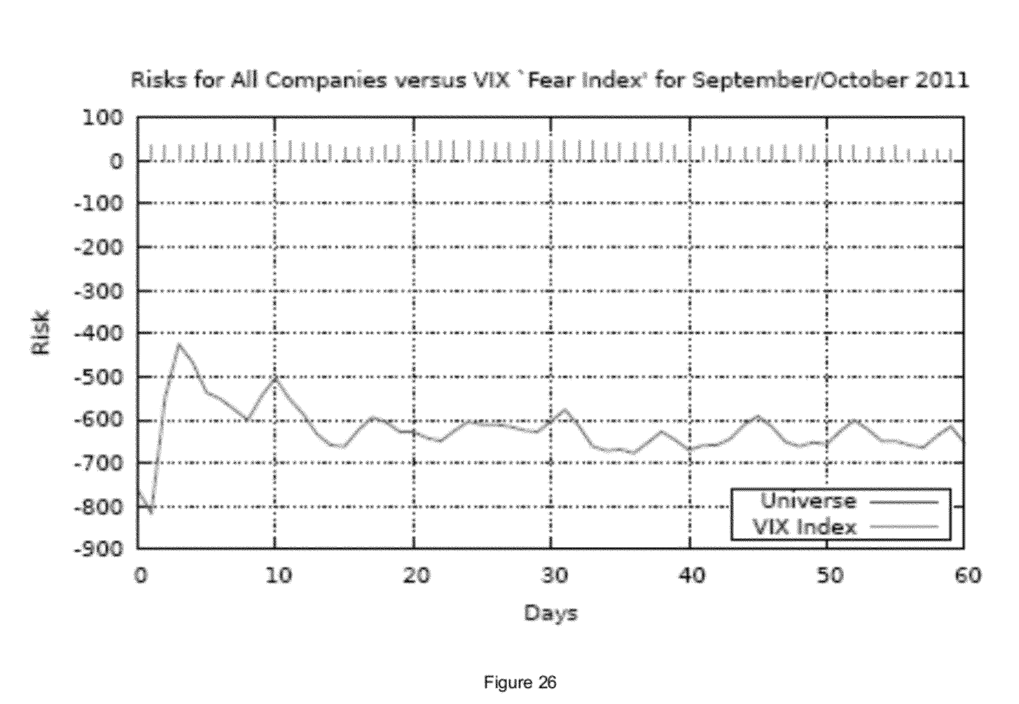

FIGS. 23-26 are exemplary graphical representations of expressions of risk and of comparisons of risk each given a 60-day window. FIG. 23 represents a risk comparison for the September/October 60-day window for Apple, Google, and IBM in the context of sets of risk that are peer normalized and smoothed. FIG. 24 represents a total risk across all companies universe for the September/October 60-day window comparison in the context of sets of risk that are peer normalized. The graphs contrast smoothed (ARMA—outlier elimination) versus unsmoothed (raw) data sets. FIG. 25 represents a risk peer trend for Eastman Kodak showing the effect of rumors of imminent bankruptcy. FIG. 26 represents a risk comparison for the all companies universe compared against the VIX (Chicago Board of Exchange “Fear Index”).

By providing an ERP that comprises multiple risk components, as opposed to the limited construct of data structures that have only a single risk component, the ERP allows the analyst to perform additional analysis using the various components. To help give more particular meaning to the use of the term risk herein, we note that, for example, two groups often concerned with evaluating risks of an entity are persons involved with 1) risk management, and 2) general business, e.g., MBAs. Risk management typically uses the term “risk” to include both negative risks and positive risks. General business types use the term “risk” or “threat” to refer only to the negative risks and use the term “opportunity” to refer to positive risk. Unless stated otherwise, we shall use the terms “negative risk” and “threat” to refer to a negative or undesired risk type and we shall use the terms “positive risk” and “opportunity” to refer to a positive or desired event or potentiality. The ERP preferably includes both positive risks and negative risks and the ERP system preferably considers both in generating the ERP.

For example, one model for evaluating and categorizing risks of companies is referred to as “SWOT” (or “SLOT”) which stands for: S—strength; W—weakness (or L—limitations); O—Opportunities; T—threats. Generally, strengths and weaknesses are considered internal factors and threats and opportunities are considered external factors. Strengths are characteristics of the business, or project team that give it an advantage over others. Weaknesses (or Limitations) are characteristics that place the team at a disadvantage relative to others. Opportunities are external chances to improve performance (e.g., make greater profits) in the environment. Threats are external elements in the environment that could cause trouble for the business or project. SWOT is a process and representation that involves specifying objectives of a business venture or project and identifying internal and external factors that are favorable and unfavorable to achieve the specified objectives. SWOT is useful in decision-making related to achieving the specified business objectives.

Often with this model, risks are categorized and are shown side-by-side or as a list. The ERP system of the present invention may be used to automatically populate some or all of a SWOT analysis/list, e.g., populate the threat quadrant with a list of negative risks identified in the ERP process and populate the opportunity quadrant with a list of positive risks identified in the ERP process. To demonstrate, normally an analyst draws four rectangles representing each SWOT quadrant and lists threats/opportunities in the respective and appropriate quadrants. The techniques of the present invention in generating an ERP may be used to automatically populate the SWOT chart with the list of opportunities and threats. For example, the list of risks provided at FIG. 20, may be input and used as the list of threats and/or opportunities in a SWOT representation.

Demonstrating the flexibility of the ERP, the analyst may be far more concerned about negative risks than positive risks, e.g., the analyst may be more concerned with avoiding downside (e.g., loss of equity) than with potential upside (stock price gain) and therefore may not want to offset the negative risk with the positive risk. To accomplish this, the system may be configured to separately generate a negative risk component and a positive risk component. On the other hand and in the alternative, the ERP may include a combined ERP that includes both positive and negative risks as one of the risk components.

The system may identify and quantify multiple general risks and/or may include some or all of idiosyncratic risks, self trends, and peer trends to make up a composite ERP. The ERP may or may not include opportunities along with threats/risks. The ERP system may be configured to generate a true risk-only based profile or a composite risk/opportunity based profile. Also, can use historical (real, observed and measured) data to determine a weighting scheme to give more effect of certain risks and/or opportunities over others based on how a stock price has behaved when similar risks/opportunities were present.

The ERP system may use historical (real, observed and measured) data to determine a weighting scheme to give more effect of certain risk types over other risk types based on how a stock price has behaved when similar risk types were present. In this manner, the system may learn what risks have greater and lesser effect on an entity or industry over time. The ERP may reflect the weighting based on this data and analysis.

While the invention has been described by reference to certain preferred embodiments, it should be understood that numerous changes could be made within the spirit and scope of the inventive concept described. In implementation, the inventive concepts may be automatically or semi-automatically, i.e., with some degree of human intervention, performed. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

We claim:

1. A computer implemented method comprising:
a. automatically analyzing by a computer a set of linguistic characteristics of a set of information associated with an entity;
b. based upon the step of automatically analyzing, automatically generating by the computer an entity-specific risk profile (“ERP”) associated with the entity, the entity-specific risk profile comprising a first risk component and a second risk component; and
c. storing the entity-specific risk profile in a memory accessible by the computer.

2. The method of claim 1 wherein the first risk component and the second risk component are from a group comprising a financial risk component, a legal risk component, an operational risk component, and a markets risk component.

3. The method of claim 1 wherein the entity-specific risk profile further comprises a third risk component and a fourth risk component.

4. The method of claim 3 wherein the third risk component and the fourth risk component are from a group comprising a financial risk component, a legal risk component, an operational risk component, and a markets risk component.

5. The method of claim 1, wherein the set of information is derived from a corpus of electronic documents.

6. The method of claim 5, wherein the corpus is one or more of a group consisting of news, financial information, legal information, regulatory information, blogs, and event streams.

7. The method of claim 6, wherein automatically analyzing a set of linguistic characteristics comprises identifying a set of entity-specific risks based at least in part on a set of risk-indicating patterns associated with the corpus.

8. The method of claim 1, wherein automatically analyzing a set of linguistic characteristics comprises identifying a set of entity-specific risks by using a risk-identification-algorithm.

9. The method of claim 8, wherein the risk-identification-algorithm is based at least in part on one or more of a group consisting of a set of terms statistically associated with risk; a temporal factor; a set of customized criteria, including one or more of industry criterion, geographic criterion, monetary criterion, and political criterion.

10. The method of claim 1 further comprising automatically transmitting an entity-specific alert upon detecting that the entity-specific risk profile meets or exceeds a predetermined risk value.

11. The method of claim 1 further comprising automatically comparing a first entity-specific risk profile associated with a first entity with a second entity-specific risk profile associated with a second entity.

12. The method of claim 11 further comprising using the results of comparing a first entity-specific risk profile associated with a first entity with a second entity-specific risk profile associated with a second entity to develop a risk-balanced portfolio of companies/securities comprising a fund or portfolio.

13. The method of claim 1 further comprising providing an electronic link with the entity-specific risk profile to link a representation of the first risk component with the set of information from which the first risk component was derived.

14. The method of claim 1, wherein the entity is one of a group consisting of a company, a person, a politically exposed person (PEP), an industry, a sector, and a member of a corporate team.

15. The method of claim 1, wherein automatically analyzing by a computer a set of linguistic characteristics of a set of information associated with an entity includes applying a risk-based taxonomy.

16. The method of claim 15, wherein the risk-based taxonomy is learned from the set of information.

17. The method of claim 1, wherein the first risk component and the second risk component are from a group comprising: general risks; idiosyncratic risks, self trend; and peer trend.

18. The method of claim 1 further comprising predicting a risk trend based on an historic time series.

19. The method of claim 18 wherein predicting a risk trend based on an historic time series further comprises applying a smoothing operation to mitigate outliers.

20. The method of claim 1 further comprising generating a set of ERPs associated respectively with a set of entities.

21. A computer-based system comprising:
a processor adapted to execute code;
a memory for storing executable code;
an input adapted to receive a set of information derived from a set of media information sources;
a first set of code when executed by the processor being adapted to automatically analyze a set of linguistic characteristics of the set of information, and to identify risks associated with an entity;
a second set of code when executed by the processor being adapted to automatically generate an entity-specific risk profile (“ERP”) associated with the entity based on the identified risks and to store the ERP in the memory, the entity-specific risk profile comprising a first risk component and a second risk component; and
an output adapted to transmit a signal associated with the generated ERP.

22. The system of claim 21 wherein the first risk component and the second risk component are from a group comprising a financial risk component, a legal risk component, an operational risk component, and a markets risk component.

23. The system of claim 21 wherein the entity-specific risk profile further comprises a third risk component and a fourth risk component.

24. The system of claim 23 wherein the third risk component and the fourth risk component are from a group comprising a financial risk component, a legal risk component, an operational risk component, and a markets risk component.

25. The system of claim 21, wherein the set of information is derived from a corpus of electronic documents.

26. The system of claim 25, wherein the corpus is one or more of a group consisting of news, financial information, legal information, regulatory information, blogs, and event streams.

27. The system of claim 26, wherein the second set of code adapted to automatically analyze a set of linguistic characteristics further comprises code which when executed by the processor is adapted to identify a set of entity-specific risks based at least in part on a set of risk-indicating patterns associated with the corpus.

28. The system of claim 21, wherein the second set of code adapted to automatically analyze a set of linguistic characteristics further comprises code which when executed by the processor is adapted to identify a set of entity-specific risks by using a risk-identification-algorithm.

29. The system of claim 28, wherein the risk-identification-algorithm is based at least in part on one or more of a group consisting of a set of terms statistically associated with risk; a temporal factor; a set of customized criteria, including one or more of industry criterion, geographic criterion, monetary criterion, and political criterion.

30. The system of claim 21 further comprising a third set of code when executed by the processor being adapted to automatically transmit an entity-specific alert upon detecting that the entity-specific risk profile meets or exceeds a predetermined risk value.

31. The system of claim 21 further comprising a fourth set of code when executed by the processor being adapted to automatically compare a first entity-specific risk profile associated with a first entity with a second entity-specific risk profile associated with a second entity.

32. The system of claim 31 further comprising a fifth set of code when executed by the processor being adapted to use the results from execution of the fourth set of code to generate an output representative of a recommended risk-balanced portfolio of companies/securities comprising a fund or portfolio.

33. The system of claim 21, wherein the ERP comprises an electronic link linking the first risk component with the set of information from which the first risk component was derived.

34. The system of claim 21, wherein the entity is one of a group consisting of a company, a person, a politically exposed person (PEP), an industry, a sector, and a member of a corporate team.

35. The system of claim 21, wherein the first set of code adapted to automatically analyze the set of linguistic characteristics of the set of information includes a set of code adapted to apply a risk-based taxonomy to identify risks.

36. The system of claim 35, wherein the risk-based taxonomy is learned from the set of information.

37. The system of claim 21, wherein the first risk component and the second risk component are from a group comprising: general risks; idiosyncratic risks, self trend; and peer trend.

38. The system of claim 21 further comprising a set of trend code when executed by the processor is adapted to predict a risk trend based on an historic time series.

39. The system of claim 38 wherein the set of trend code further comprises a set of smoothing code adapted to perform a smoothing operation on data related to the historic time series to mitigate outliers.

40. A computer implemented automated method comprising:
a. aggregating a set of risk related information;
b. generating a categorized set of risk related information by associating the set of risk related information with at least one risk type from a set of risk types, the set of risk types comprising an operational risk type, a legal risk type, a markets risk type, and a financial risk type; and
c. electronically storing the categorized set of risk related information.

41. The method of claim 40, wherein generating a categorized set of risk related information includes applying a risk-based taxonomy.

42. The method of claim 41, wherein the risk-based taxonomy is learned at least in part from a corpus of electronic documents.

43. The method of claim 40, wherein the set of risk related information is derived at least in part from a corpus of electronic documents.

44. The method of claim 43, wherein the corpus is one or more of a group consisting of news, financial information, legal information, regulatory information, blogs, and event streams.

45. The method of claim 40, wherein aggregating the set of risk related information includes automatically analyzing a set of linguistic characteristics to identify a set of entity-specific risks based at least in part on a set of risk-indicating patterns associated with the corpus.

46. The method of claim 40, wherein aggregating the set of risk related information includes automatically analyzing a set of linguistic characteristics to identify a set of entity-specific risks by using a risk-identification-algorithm.

47. The method of claim 40, wherein generating a categorized set of risk related information is based at least in part on one or more of a group consisting of a set of terms statistically associated with risk; a temporal factor; a set of customized criteria, including one or more of industry criterion, geographic criterion, monetary criterion, and political criterion.

48. The method of claim 40, wherein the set of risk related information is associated with one or more entities.
